(19) United States
(12) Patent Application Publication
(10) Pub. No.: US 2026/0178595 A1
(43) Pub. Date: Jun. 25, 2026

(54) False Information Mitigating in Knowledge Processing Frameworks

(71) Applicant: REGENTS OF THE UNIVERSITY OF MICHIGAN, Ann Arbor, MI (US)

(72) Inventors: Vansh Sharma, Ann Arbor, MI (US); Venkat Raman, Ann Arbor, MI (US)

(21) Appl. No.: 19/423,483

(22) Filed: Dec. 17, 2025

Related U.S. Application Data
(60) Provisional application No. 63/736,423, filed on Dec. 19, 2024.

(51) Int. Cl. G06F 16/2457; G06F 16/248

(52) U.S. Cl. CPC G06F 16/24578; G06F 16/248

(57) ABSTRACT

Techniques are provided for a large language models (LLM) to reduce risks associated with potential introduction of factual inaccuracies and/or hallucinations in responses to user queries to the LLM, for example when responding to user queries pertaining to advanced scientific fields. One or more documents from a document corpus are identified to generate a response to a user query, and relevant information points for (e.g., citations to) the one or more documents are associated therewith to demonstrate accuracy of the response. Validation techniques may be provided to further ensure accuracy of the response to the user query.

### STATEMENT OF GOVERNMENT INTEREST

This invention was made with government support under HDTRA1-21-1-0012 awarded by the Defense Threat Reduction Agency, and FA9550-24-1-0017 awarded by the Air Force Office of Scientific Research. The government has certain rights in the invention.

### CROSS-REFERENCE TO RELATED APPLICATIONS

The present disclosure claims priority to U.S. Provisional Application Ser. No. 63/736,423 filed Dec. 19, 2024, the entire contents of which is hereby incorporated by reference.

### FIELD

The present disclosure is generally related to the integration of artificial intelligence (AI), machine learning (ML), and other predictive models on personal computers, mobile devices, and/or edge devices, and more particularly, to techniques enabled by controlled and validated implementations of machine learning models.

### BACKGROUND

Integrating Large Language Models (LLMs) into complex research environments, such as scientific data retrieval, involves processing input queries and retrieving information from large, unstructured datasets, like research articles, technical reports, and technical data. By employing Retrieval-Augmented Generation (RAG) frameworks, these models retrieve external knowledge from a datastore or document corpus, then generate responses based on both the input query and the retrieved data. However, such frameworks pose challenges where LLMs are prone to hallucinations, generating factually incorrect or irrelevant information. In research-intensive fields, these hallucinations can lead to flawed analysis or misguided decision-making, which could compromise the accuracy and safety of experimental or theoretical conclusions.

Additionally, many implementations of LLMs involve sending data to third-party APIs for processing, introducing data privacy risks. Sensitive or proprietary research data is often exposed to external services, where privacy protections may be inadequate or terms of service unclear, creating risks of unauthorized access or data breaches. These concerns are heightened when models possess persistent memory, potentially retaining sensitive information and leading to inadvertent data exposure. This issue becomes particularly relevant when models are trained on datasets containing unmasked personal identifiers or other confidential information embedded in the training process, exposing them to unintended data retention.

### SUMMARY

In one embodiment, a computer-implemented method is provided. The method may include (1) obtaining, via one or more processors, a user query from a user, (2) embedding, via the one or more processors, the user query to generate one or more query embeddings, (3) identifying, via the one or more processors, from a plurality of corpus embeddings representing content of one or more documents in a document corpus, a subset of one or more corpus embeddings relevant to the user query, based on comparison of the one or more query embeddings to the plurality of corpus embeddings, (4) associating, via the one or more processors, one or more relevant information points with the identified subset of corpus embeddings, the one or more relevant information points indicating one or more locations in the document corpus corresponding to the identified subset of corpus embeddings, (5) generating, via one or more processors, a response to the user query based on the identified subset of corpus embeddings and the one or more relevant information points, and/or (6) providing, via the one or more processors, the generated response to the user. The method may include additional, fewer, and/or alternate actions, including actions described herein, in various embodiments.

In another embodiment, one or more non-transitory computer readable media are provided. The one or more non-transitory computer readable media store instructions that, when executed via one or more processors of one or more computers, cause the one or more computers to (1) obtain a user query from a user, (2) embed the user query to generate one or more query embeddings, (3) identify from a plurality of corpus embeddings representing content of one or more documents in a document corpus, a subset of one or more corpus embeddings relevant to the user query, based on comparison of the one or more query embeddings to the plurality of corpus embeddings, (4) associate one or more relevant information points with the identified subset of corpus embeddings, the one or more relevant information points indicating one or more locations in the document corpus corresponding to the identified subset of corpus embeddings, (5) generate a response to the user query based on the identified subset of corpus embeddings and the one or more relevant information points, and/or (6) provide the generated response to the user. The one or more non-transitory computer readable media may include additional, fewer, and/or alternate instructions, including instructions to perform various actions described herein, in various embodiments.

In still another embodiment, a computing system is provided. The computing system may include one or more processors and one or more non-transitory memories storing instructions. The instructions, when executed via the one or more processors, may cause the computing system to (1) obtain a user query from a user, (2) embed the user query to generate one or more query embeddings, (3) identify from a plurality of corpus embeddings representing content of one or more documents in a document corpus, a subset of one or more corpus embeddings relevant to the user query, based on comparison of the one or more query embeddings to the plurality of corpus embeddings, (4) associate one or more relevant information points with the identified subset of corpus embeddings, the one or more relevant information points indicating one or more locations in the document corpus corresponding to the identified subset of corpus embeddings, (5) generate a response to the user query based on the identified subset of corpus embeddings and the one or more relevant information points, and/or (6) provide the generated response to the user. The computing system may include additional, fewer, and/or alternate components, and may be configured to perform additional, fewer, and/or alternate actions, in various embodiments.

### BRIEF DESCRIPTION OF THE DRAWINGS

The patent or application file contains at least one drawing executed in color. Copies of this patent or patent application publication with color drawing(s) will be provided by the United States Patent and Trademark Office upon request and payment of the necessary fee.

The figures described below depict various aspects of the system and methods disclosed herein. It should be understood that each figure depicts an aspect of a particular aspect of the disclosed system and methods, and that each of the figures is intended to accord with a possible aspect thereof. Further, wherever possible, the following description refers to the reference numerals included in the following figures, in which features depicted in multiple figures are designated with consistent reference numerals.

There are shown in the drawings arrangements which are presently discussed, it being understood, however, that the present embodiments are not limited to the precise arrangements and instrumentalities shown, wherein:

FIG. 1 depicts a block diagram of an example computing environment including a knowledge processing device, according to an aspect;

FIG. 2A depicts a flow diagram of an example method of embedding a user query to an LLM, according to an aspect;

FIG. 2B depicts a flow diagram of an example method of generating a response to a user query via an LLM, according to an aspect;

FIG. 2C depicts a flow diagram of an example method of providing a validating a generated response to a user query, according to an aspect;

FIG. 3 depicts a flow diagram of an example method of embedding documents from a corpus and organizing the embedded documents in a datastore for future retrieval, according to an aspect;

FIG. 4 depicts a flow diagram of an example method of generative answering using a RAG framework integrated with an LLM, according to an aspect;

FIG. 5 depicts a flow diagram of another example method of providing a response to a user query, according to an aspect;

FIG. 6 depicts a flow diagram of still another example method of providing a response to a user query via a retrieval-augmented generation framework, according to an aspect;

FIG. 7A depicts example an example user query to one or more LLMs and example responses thereto, according to an aspect; and

FIG. 7B depicts another additional user query to one or more LLMs and example responses thereto, according to an aspect.

FIG. 8A depicts a flow diagram of an example method of processing source code files and constructing a graph data structure for code-specific analysis, according to an aspect.

FIG. 8B depicts a flow diagram of an example method of processing user queries using a hybrid retrieval approach combining semantic similarity search with graph-based expansion for code-specific analysis, according to an aspect.

FIG. 8C depicts a flow diagram of an example method of validating responses generated from code-specific queries and appending relevant information points before transmission to a user, according to an aspect.

The figures depict preferred embodiments for purposes of illustration only. Alternative embodiments of the systems and methods illustrated herein may be employed without departing from the principles of the invention described herein.

### DETAILED DESCRIPTION

The present disclosure recognizes a growing need for platforms that enable secure, controlled, and validated interactions with LLMs. The present disclosure identifies that interactions with LLMs should ensure compliance with data privacy regulations while mitigating the risks of hallucinations and inaccuracies in content generated by LLMs.

Conventional methods for training and operating an LLM, such as reinforcement learning from human feedback (RLHF) and fine-tuning, face several challenges. RLHF typically require large & extensive datasets coupled with carefully curated human feedback, which poses risks such as data contamination, limited scalability, and privacy breaches due to the inclusion of sensitive data in the datasets and/or human feedback. RLHF methods, while effective in improving model alignment with human preferences, is particularly limited when datasets are sparse or highly specialized, as seen in niche domains.

Additionally, conventional LLM approaches may be limited by their susceptibility to hallucinations and inaccuracies, as well as challenges in ensuring data traceability and output verification. These conventional approaches may also struggle to efficiently manage and retrieve domain-specific information or adequately process the vast and diverse data sources to generate accurate responses to queries to the LLM. For instance, finely-tuned models may struggle to process large amounts of heterogeneous data, such as experimental datasets, pilot studies, device-scale simulations, and published scientific literature. Conventional approaches, therefore, are often inefficient in dealing with such multidimensional data and ensuring the traceability of sources used in their outputs.

The systems and methods described herein may integrate advanced knowledge retrieval mechanisms within an LLM framework, ensuring dependable, domain-specific outputs. By employing customizable prompt templates and retrieval-augmented generation techniques, these approaches may reduce or eliminate the need for continuous model retraining for an LLM, providing a cost-effective, scalable solution for domain-specific tasks, while maintaining data privacy and mitigating the risks associated with exposing sensitive data to external APIs.

The systems and methods described herein may further enhance the performance of LLMs by incorporating prompt-agnostic strategies and finely-tuned models, specifically designed for navigating and processing scientific research data. The techniques described herein may retrieve information from diverse sources, including experimental data, simulations, and peer-reviewed journal articles, facilitating reliable, multifaceted knowledge extraction.

To further ensure that responses to user queries to the LLM are generated from accurate, relevant, and up-to-date data sources, the described system and methods may employ document chunking, and generate and use vector embeddings representing respective document chunks. These techniques may advantageously facilitate generation of relevant and factually accurate responses across a diverse range of research-intensive domains.

To further mitigate the risks of hallucination and inaccurate response generation, the systems and methods described herein may incorporate an advanced detection and validation workflow. For example, in embodiments, techniques described herein may include cross-referencing output of the LLM with retrieved corpus embeddings and associated metadata to ensure that inaccuracies in LLM output (e.g., inaccurate responses to a user query) are identified and corrected before the response is transmitted to the user. The dynamic generation of embeddings from document chunks, coupled with the use of vector-based similarity searches, may improve the degree of relevance and accuracy in responses to queries to the LLM.

In embodiments, systems and methods described herein may additionally or alternatively incorporate relevant information point generation techniques, e.g., by appending references to relevant information points (e.g., citations, excerpts, and/or structured data) to the input corpus from which information was retrieved to formulate a response to a user query, ensuring that particular portions of information included in a response to a user query are traceable and verifiable.

### Example System

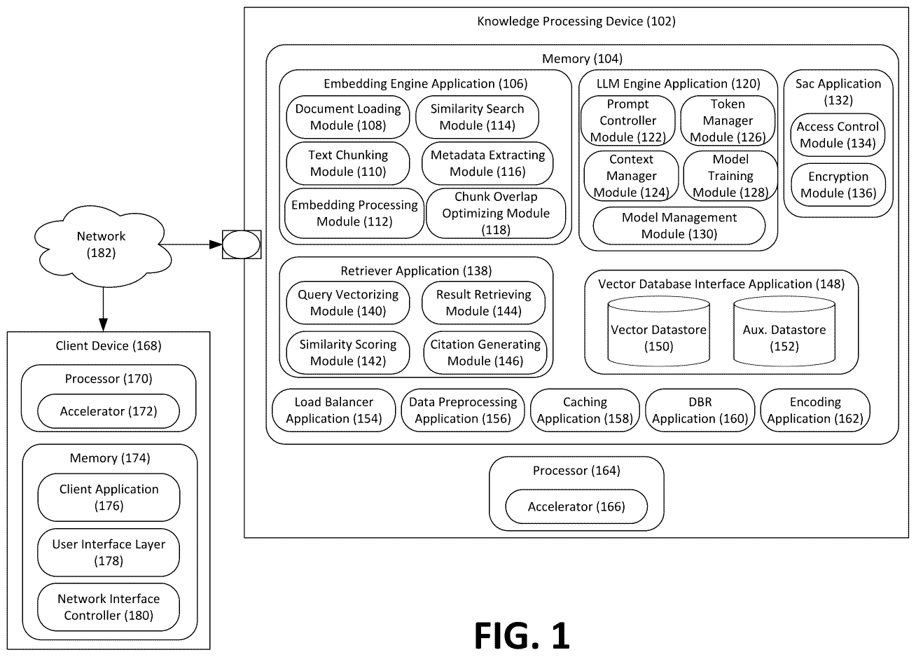

FIG. 1 depicts a block diagram of an example computing environment 100 including a knowledge processing device (KPD) 102 according to some aspects. The KPD 102 may, for example, include one of more servers. At a high level, the KPD 102 includes a memory 104 (i.e., one or more memories, e.g., non-transitory memories) storing instructions that, when executed by a processor 164 (i.e., one or more processors), cause the KPD 102 to perform various functions that will be described herein. At least a portion of these functions may, for example, include communicating with a client device 168 via a network 182, and/or processing a user query to an LLM received via the client device 168 via the network 182. As will be described further herein, the memory 104 of the KPD 102 may include various applications and modules therein, each of which may correspond respectively to sets of computer-executable instructions stored at a non-transitory portion of the memory 104.

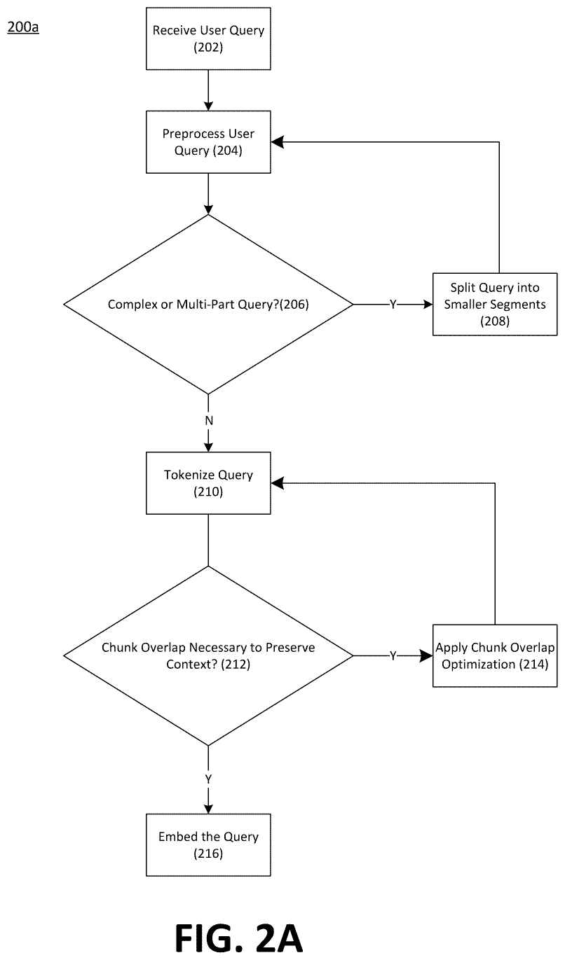

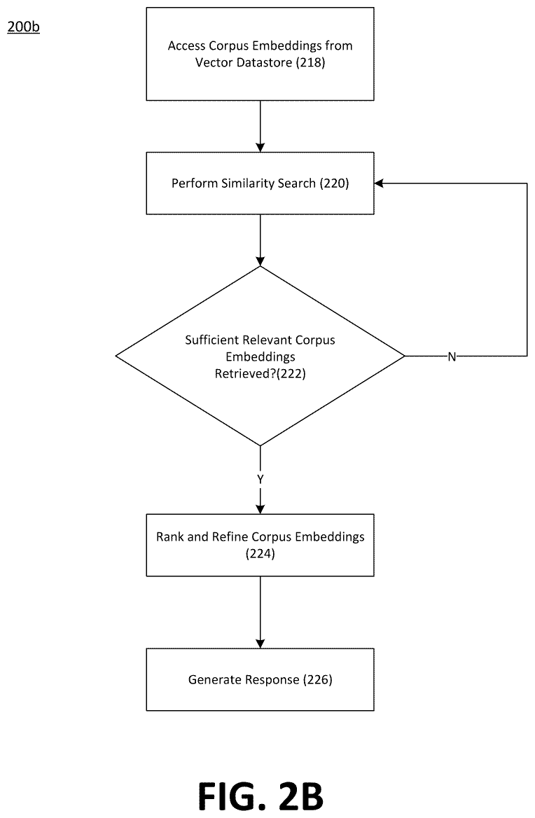

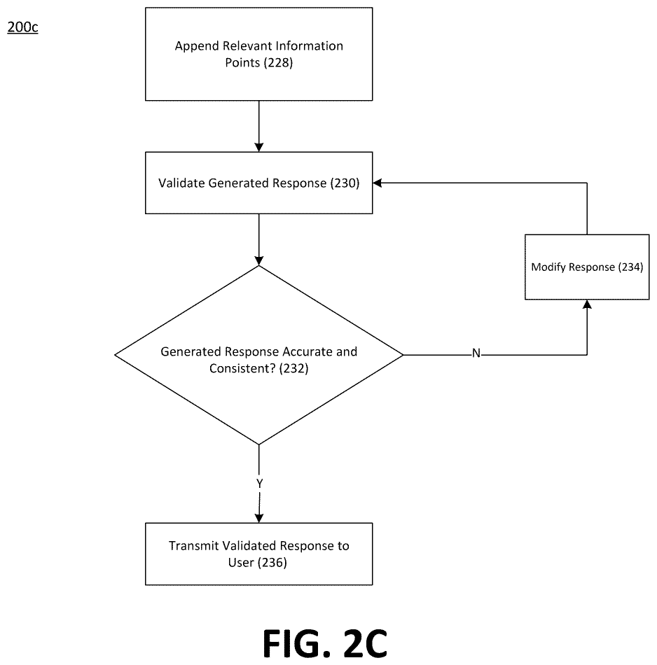

As depicted in FIG. 1, applications stored in the memory 104 may include at least an embedding engine application 106, a retriever application 138, an LLM engine application 120, a vector datastore interface application 148, a data preprocessing application 156, a security and access control (SaC) application 132, a load balancer application 154, a caching application 158, a data backup and redundance (DBR) application 160, and/or an encoding application 162. Arrows in FIG. 1 interconnecting the applications and/or other components of the environment 100 generally represent communications and logical interconnections between the interconnected components. It should be appreciated, though, that additional or alternative communications and/or logical interconnections may be envisioned in various embodiments. Functions of each respective application will be understood from description of various modules included therein, in this portion of this description and with respect to various example methods depicted in FIGS. 2A-2C and FIGS. 3-6.

The memory 104 may include volatile and/or non-volatile memory, such as RAM, ROM, SSD, HDD, and/or flash memory. The memory 104 may store computer-executable instructions that the processor 164 (i.e., one or more processors) executes to conduct various actions attributed herein to the KPD 102 and the applications/modules therein (e.g., document retrieval and response generation functions).

In embodiments implementing code-specific analysis (e.g., CodeGraphRAG), code symbols may include functions, classes, methods, variables, data structures, type definitions, constants, interfaces, and other programmatic elements extracted from source code files. For example, in a Python codebase, code symbols may include function names (e.g., “calculate_similarity”), class names (e.g., “EmbeddingProcessor”), method names (e.g., “process_query”), variable declarations, import statements, and other identifiable code constructs. In a Java codebase, code symbols may include class definitions, interface declarations, method signatures, field variables, and package imports. Each code symbol may be represented as a node in a graph data structure, with edges representing structural relationships such as function calls, class inheritance, method invocations, variable references, import dependencies, and other programmatic connections. The extraction and representation of code symbols enables the system to perform both semantic similarity searches (based on conceptual meaning) and structural relationship traversals (based on code architecture) when processing queries related to source code.

The processor 164 may include one or more central processing units (CPUs), graphical processing units (GPUs), neural engines, and/or other specialized processing units. The processor 164 may be configured to execute computer-executable instructions that enable operations such as corpus embedding generation, query embedding comparison, similarity searches, managing vector databases, LLM-based response generation, and other actions described herein. These processing tasks can involve significant computational complexity, particularly when working with large document corpora and performing real-time query handling. In some embodiments, the GPU may be used to relieve processing demands on the CPU accelerate the processing of corpus embeddings or natural language inference, while the CPU manages general processing tasks such as interacting with the vector datastore 150. The processor 164 may also be used in parallelized operations to optimize the performance of the KPD 102. Parallelized operations may include using multi-threading or GPU-based processing for document retrieval tasks.

In embodiments, the processor 164 includes an accelerator 166, which may include one or more hardware and/or software components specifically configured to accelerate the performance of AI and ML tasks within the KPD 102. In certain embodiments, the accelerator 166 may be utilized by the embedding engine application 106 and the LLM engine application 120 to optimize the processing of high-dimensional embeddings and the generation of responses to user queries. The accelerator 166 may comprise specialized processors such as graphics processing units (GPUs) (e.g., NVIDIA A100, Gaudi2, or Gaudi3), tensor processing units (TPUs), or other hardware accelerators specifically designed to handle computationally intensive operations related to AI/ML workflows.

The KPD 102 also may include a network interface controller (NIC), which facilitates communication between the KPD 102 and external systems or databases over the network 182. The network 182 can include, for example, the Internet, a local area network (LAN), a wide area network (WAN), or a cloud-based network, and/or another one or more networks allowing the KPD 102 to connect to the client device 168 and/or to other external components for LLM query handling, retrieval processes, and/or other functions described herein.

The KPD 102 may, for example, comprise one or more servers. However, in embodiments, the KPD 102 may include various physical devices and/or cloud infrastructure configured to process queries, retrieve document chunks, generate responses using LLMs, and/or perform other actions attributed to the KPD 102 in this disclosure.

In any case, moving to applications and modules stored at the memory 104, the SaC application 132 may include an access control module 134 that may ensure only authorized users can access LLM functionalities, documents and/or other data underlying the LLM, and/or other aspects of the systems and methods described herein. The SaC application 132 may additionally or alternatively include an encryption module 136 configured to encrypt and secure sensitive data during transmission (e.g., to and/or from the client device 168) and storage (e.g., at the KPD 102).

The KPD 102 may further include a model management module 130, which may store a model versioning module to track updates to the LLM. Still additionally or alternatively, the KPD 102 may include a model training module 128 configured to allow fine-tuning or retraining of the LLM with new data.

For workload management and scalability, KPD 102 may include a load balancer application 154 to distribute computational loads across the processor 164 (e.g., including the accelerator 166). The KPD 102 may further store a data preprocessing application 156 to clean and format data before it the data is processed by the embedding engine application 106. To reduce latency for frequently accessed queries, the KPD 102 may also store a caching application 158 to cache responses to previous queries to the LLM. The environment 100 may also include a user interface layer 178 of the client device 168 for interaction with the KPD 102, a model evaluation module of the KPD 102 designed to monitor system performance and optimize output quality through a continuous feedback loop, and/or the DBR application 160 of the KPD 102 to ensure reliable data storage and system recovery in case of failure.

The vector datastore 150 serves as a specialized repository configured to support the operations of the KPD 102, and may store the high-dimensional vector embeddings generated from documents. The vector datastore 150 may be implemented as a standalone vector database, or integrated within a broader data management framework, utilizing suitable storage techniques (e.g., Faiss, Chroma, Qdrant, Vespa, and/or other vector database systems). Moreover, within vector datastore 150, data may be systemically organized into vector embeddings, semantic indexes, and metadata collections, facilitating efficient similarity searches and retrieval of relevant document chunks, facilitating the expedient and accurate of relevant corpus embeddings during query processing. In other configurations, the system may use distributed databases (e.g., CockroachDB, Google Spanner) or cloud-based databases (e.g., Amazon RDS, Google Cloud Datastore) for high scalability and availability. Documents from which vectors are generated may for example include exclusively text (e.g., formatted and/or unformatted text), or alternatively, may include multi-modal content in the form of text in combination with one or other forms of content (e.g., image, video, audio, etc.).

The vector datastore 150 may store pre-processed embeddings used by the embedding engine application 106 and the retriever application 138 to interact with large language models, further enabling intelligent data retrieval and response generation. Moreover, within vector datastore 150, data may be systematically organized into schemas, tables, collections, or documents to store user interactions and metadata, facilitating the maintenance of complex data relationships and enabling advanced data analysis and the enhancement of machine learning algorithms. The vector datastore 150 may store data used to train and/or operate one or more interactive content models. The vector datastore 150 may store runtime data (e.g., a document received via the network, etc.).

In some embodiments, the auxiliary datastore 152 may be configured to provide supplemental storage for metadata, relevant information points of documents (e.g., citations, excerpts, data tables, images, and/or other structured data), graph data structures representing code structure, and extended chunks retrieved by the KPD 102. The auxiliary datastore 152 may further facilitate the generation of relevant information points for documents identified as relevant to a user query, ensuring that relevant references are accurately appended in the responses produced via the LLM. In some implementations, the auxiliary datastore 152 may also store additional information not stored within the vector datastore 150, including for example document metadata, extended sections of input corpus, and/or related contextual information. In some embodiments, by decoupling core embeddings from supplementary metadata into distinct storage units, the auxiliary datastore 152 may advantageously increase the ability of the KPD 102 to manage large volumes of data efficiently, allowing for continuous updates and streamlined access to supporting information during response generation. In some embodiments, the graph data structure stored in the auxiliary datastore 152 may be implemented as a directed graph, an undirected graph, or a hybrid structure, depending on the nature of the structural relationships being represented. In some embodiments, the graph data structure may be stored in a graph database, a relational database, or other suitable storage mechanism

In embodiments implementing code-specific analysis, the auxiliary datastore 152 may store a graph data structure having nodes representing code symbols extracted from source code files and edges representing structural relationships between the code symbols, wherein each node is associated with a corresponding corpus embedding from the plurality of corpus embeddings stored in the vector datastore 150. In embodiments implementing code-specific analysis, the auxiliary datastore 152 may store a graph data structure having nodes representing code symbols extracted from source code files and edges representing structural relationships between the code symbols, wherein each node is associated with a corresponding corpus embedding from the plurality of corpus embeddings stored in the vector datastore 150.

In some implementations, the auxiliary datastore 152 may also store additional information not stored within the vector datastore 150, including for example document metadata, extended sections of input corpus, code symbol metadata (e.g., file paths, line numbers, function signatures, parameter types, return types), and/or related contextual information. In some embodiments, by decoupling core embeddings from supplementary metadata into distinct storage units, the auxiliary datastore 152 may advantageously increase the ability of the KPD 102 to manage large volumes of data efficiently, allowing for continuous updates and streamlined access to supporting information during response generation.

In some embodiments, users may select an appropriate open-source large language model (LLM), such as one or more open source models from the Llama family, with the option to configure models based on specific hardware and system requirements. Users may also choose models with large token limits, allowing processing of a substantial number of embeddings within a single interaction efficiently. These models may be adapted or optimized for execution across various hardware environments, including, but not limited to, CPUs, GPUs, and TPUs, by employing techniques such as quantization, which reduces the memory footprint and improves inference speed.

Furthermore, the KPD 102 may employ model optimization techniques (e.g., quantization, re-training, fine-tuning, pruning, etc.) to enhance the execution of the LLM based on the available hardware. For example, the KPD 102 may optimize model execution to improve latency and memory usage for the accelerator 166 (e.g., Gaudi 2, Gaudi 3, or Intel Xeon CPUs). The optimizations may also (or alternatively) include adjusting encryption parameters or exchanging certain processor operations for more efficient alternatives, thereby enhancing the overall performance of the LLM on the selected hardware. Moreover, these optimizations may allow the LLM to manage larger token limits, ensuring that the processing of embeddings and response generation is efficient and scalable across distributed environments, including multi-GPU setups.

The KPD 102 may further include an encoding application 162, which may be configured to facilitate vector embedding generation across the embedding engine application 106 and the retriever application 138. The encoding application 162 may transform document content (e.g., semantic content of text, and/or other content such as image, video, audio multi-modal combinations of text and image/video/audio content, etc.) and incoming user query data into high-dimensional vector embeddings, which may serve as a foundation for similarity search operations and retrieval functionality.

In various implementations, the encoding application 162 may receive data inputs, including textual, image/video, and/or other content, metadata, or multimodal information, and process these inputs using embedding techniques to generate vector representations. These vector embeddings may provide a semantically enriched format for search and retrieval. The encoding application 162 may utilize neural network-based models, such as transformer or recurrent neural network (RNN) architectures, or alternative embedding algorithms to capture relationships within the processed data. In some embodiments, the encoding application 162 may be optimized for high-throughput embedding generation using hardware accelerators, such as GPUs or TPUs.

The encoding application 162 may interface with an embedding processing module 112, the vector datastore interface application 148, and a similarity search module 114, enabling corpus embeddings to be structured, processed, and stored in the vector datastore 150. The embedding configurations produced by the encoding application 162 may then be used for comparison against user query embeddings, potentially enhancing retrieval precision. Stored embeddings may be optimized within the vector datastore 150 similarity search across high-dimensional vector spaces, which may support efficient document retrieval within larger datasets.

Additionally, the encoding application 162 may support retriever application 138 by converting incoming user queries into corresponding vector representations. This may allow for query embeddings to be compared against corpus embeddings in the vector datastore 150, with minimal latency, through similarity algorithms selected by a similarity scoring module 142, such as cosine similarity, maximum marginal relevance (MMR), or inner product distance. In some configurations, the encoding application 162 may contribute to reduced query-to-response times and may support retrieval accuracy. This may allow for query embeddings to be compared against corpus embeddings in the vector datastore 150, with minimal latency, through a similarity criterion, similarity measure, or similarity algorithm selected by a similarity scoring module 142, such as cosine similarity, maximum marginal relevance (MMR), or inner product distance.

In further embodiments, the encoding application 162 may also support multi-modal embedding generation, which may allow for the processing and encoding of non-textual data inputs, such as image or audio data. This may enable a broader range of user queries and document types to be accommodated by translating diverse data formats into compatible embeddings within a shared vector space.

In operation, a user may access functionalities of the KPD 102 via a client device 168. More particularly, the client device 168 may include a memory 174 (i.e., one or more memories, for example one or more non-transitory memories) storing instructions executable by a processor 170 (i.e., one or more processors). A user of the client device 168 may, for example, be a human user of a chat system, a fully autonomous client such as a script, etc. The memory 174 may store a client application 176 that may provide a query input to the LLM over the network 182. The query can, for example, include a natural language question related to one or more specific domains, such as combustion science, other technical research, etc. The client device 168 transmits the query to the KPD 102, which uses the embedding engine application 106, retriever application 138, LLM engine application 120, and/or other applications and modules therein to generate and validate a response as described herein. The client application 176 may thereby enable tasks such as technical question answering, scientific document summarization, content generation, relevant information point extraction, literature review support, and research paper translation via one or more graphical or text-based user interfaces. In embodiments, the client application 176 may also support non-interactive and/or batch processing of scientific corpora to automate data analysis, experimental decision-making, research workflow optimization, content production, or other similar operations specific to scientific research domains.

The LLM engine application 120 may be configured to operate with multiple LLMs, including for example transformer-based models (e.g., LLaMA-2, Falcon, etc.) and/or other models fine-tuned for particular scientific applications. In one embodiment, users may select specific LLMs with larger token limits to enhance the ability of the LLM to handle more extensive embeddings and queries in a single interaction. The LLMs may be adapted or optimized for different hardware environments, such as CPUs or GPUs (e.g., NVIDIA GPUs with 96 GB VRAM), through techniques like model quantization, pruning, or fine-tuning to improve memory efficiency and inference speed.

When the KPD 102 receives the user query (e.g., via the processor 164 executing the client application 176), the retriever application 138 routes the query to the embedding engine application 106, which embeds the query into a high-dimensional vector representation. The embedding engine application 106 may include modules such as a document loading module 108, a text chunking module 110, and embedding processing module 112, which transform user queries and/or document chunks into vector embeddings. These embeddings are stored in the vector datastore 150, which supports similarity search mechanisms.

The similarity search module 114 deploys similarity algorithms (e.g., cosine similarity, Euclidean distance, maximum marginal relevance (MMR), and/or inner product) to compare the query embeddings against the corpus embeddings stored in the vector datastore 150 to find the most relevant matches of corpus embeddings to the query. The similarity search module 114 may contain instructions to select an appropriate similarity search algorithm(s) based on the configuration of the environment 100.

After relevant document chunks are identified based on relevant matches identified via the similarity search, the retriever application 138 may retrieve documents corresponding to the identified document chunks. The retriever application 138 may include modules such as a query vectorizing module 140, a similarity scoring module 142, and/or a result retrieving module 144, which may select the document chunks most relevant to the query and pass the selected document chunks to the LLM engine application 120. The KPD 102 may ensure that the retrieved data is within token limits specified by the LLM.

Once the relevant document chunks are retrieved, the relevant document chunks are passed to the LLM engine application 120. The LLM processes the retrieved chunks and the user query to generate a coherent and scientifically accurate response to the user query. In this process, the auxiliary datastore 152 may store or otherwise obtain additional metadata, relevant information points (e.g., citations, data tables, excerpts, images, etc.), and/or extended sections of input corpus that may be necessary for a thorough response to the user query. The auxiliary datastore 152 may support relevant information point generation and may store supplementary data that is not part of the core embeddings in the vector datastore 150.

Before a final response is returned to the user, the KPD 102 performs a validation check on the generated response, e.g., via the model management module 130). This validation may include consistency checks to ensure the response matches the content (e.g., semantic, and/or other content) of the retrieved document chunks, factual accuracy assessments, and confirmation that relevant information points are correctly generated from the auxiliary datastore 152. If inconsistencies or errors are detected, the system may modify the response, apply corrections, or return an error message to the user to maintain high standards of information integrity and accuracy.

Further description of example functionalities of components of FIG. 1 will be provided with respect to FIGS. 2A-2C, 3, 4, 5, and 6. It should be appreciated that the environment 100 may include additional, fewer, and/or alternate components, in various embodiments.

### Example Methods

FIGS. 2A-2C and 3-6 depict respective flow diagrams of various methods, in accordance with various embodiments. The methods of FIGS. 2A-2C, 3, 4, 5, and/or 6 may be implemented by combinations of hardware, software, firmware, etc. For example, in various examples that will be provided in this detailed description, actions of the methods of FIGS. 2A-2C, 3, 4, 5, and/or 6 may be performed by components of the environment 100 of FIG. 1 (e.g., the KPD 102 and components thereof). It should be appreciated, though, that various other implementations are possible, including implementations via other arrangements of hardware and/or software.

Beginning with FIGS. 2A-2C, methods 200a, 200b, and 200c are respectively depicted, each method generally relating to information retrieval and querying using a RAG framework integrated with an LLM. The methods, at a high level, involve retrieving relevant corpus embeddings from a pre-processed document corpus, generating a structured response to a user query based on the retrieved embeddings, and delivering the structured response. The methods of FIGS. 2A-2C may be performed via the environment 100 from FIG. 1, including for example the embedding engine application 106, retriever application 138, LLM engine application 120, and/or supporting hardware such as processor 164 and memory 104. The various modules operate in concert to ensure accurate, efficient, and secure data processing and response generation. In embodiments, the methods 200a, 200b, and 200c may be combined, e.g., with actions of the method 200b following the actions of method 200a, and/or the actions of method 200c following the actions of the method 200b and/or 200a.

Moving first to FIG. 2A, the method 200a generally relates to processing and embedding a user query, according to an aspect. The method may include, at step 202, receiving a user query for processing by the LLM. For example, user may interact with the KPD 102, by inputting a user query via the client application 176. The client application 176 may be accessed, for example, through a user interface layer 178, which may be installed on the client device 168. The user query may, for instance, be entered by the user in natural language. This flexibility (e.g., unstructured response of user query) may advantageously allow users to ask questions in a conversational manner, while still pertaining to one or more specific domains, such as scientific research, technical documentation, and/or any field requiring detailed information retrieval.

At step 204, once the user query is received, the user query may be preprocessed by the prompt controller module 122 and the data preprocessing application 156. This preprocessing may involve analyzing the structure and content of the user query. For example, the prompt controller module 122 may ensure that the user query conforms to specific, internal processing requirements. Additionally, preprocessing by the data preprocessing application 156 may involve identifying and addressing issues in the user query. For instance, the data preprocessing application 156 may, in some implementations, check for unnecessary whitespace, redundant punctuation, or special characters that could interfere with query handling.

At decision 206, the prompt controller module 122 may evaluate a complexity of the user query. This evaluation may involve assessing whether the query contains multiple questions or exhibits a high degree of complexity, such as ambiguous phrasing or intricate language structures. For example, if the user query is identified as too complex or a multi-party query, the prompt controller module 122 may re-transmit the user query back to the data preprocessing application 156 to further pre-process the user query, e.g. by splitting the query into two, three, four or more smaller segments (step 208). This iterative pre-processing by the data preprocessing application 156 may advantageously allow the prompt controller module 122 and other downstream components within the KPD 102 to more efficiently process each part of the query.

Conversely, if the user query is deemed not too complex or has already been handled as a multi-part query (e.g., as determined at decision 206), then at step 210, the prompt controller module 122 may forward the user query directly to the token manager module 126. In such embodiments, the token manager module may segment the user query into smaller components (e.g., “tokens”). By tokenizing the user query, the token manager module 126 may enable the embedding processing module 112 to match each token with the relevant corpus embeddings during the retrieval process, thereby improving the relevance and accuracy of the generated responses. For example, a long sentence may be split into multiple tokens that represent individual words, punctuation marks, or meaningful parts of compound words, allowing for precise comparison with the content of the corpus embeddings. For example, a long user-query may be tokenized into multiple tokens that represent individual words, punctuation marks, or meaningful parts of compound words, allowing for precise comparison with the content of the stored documents.

Once the user query has been tokenized, at decision 212, it may be determined whether chunk overlap is necessary to preserve context. In some embodiments, at step 214, the chunk overlap optimizing module 118 may segment the user query by dividing it into overlapping chunks at step 214. In certain implementations, this may involve splitting the user query so that each chunk contains some tokens from the preceding chunk, ensuring that key relationships between words are maintained. The prompt controller module 122 may coordinate this decision-making process and manage the handoff to the chunk overlap optimizing module 118, if applicable. For example, in a query involving “neural network optimization,” the chunk overlap optimizing module 118 may ensure that the terms “neural network” and “optimization” remain connected across overlapping chunks. If the term were to be split without overlap, important semantic context linking “neural network” to “optimization” may be lost. However, without overlapping chunks, both “neural network” and “optimization” remain connected across multiple chunks, preserving their semantic relationship. This overlapping strategy improves the accuracy of the embedding process performed by the embedding engine application 106 in downstream operations of method 200a. By ensuring that meaningful portions of the query are carried through multiple chunks, the chunk overlap optimizing module 118 enhances the ability of the embedding engine application 106 to capture complex relationships within the user query. This step is especially important when dealing with highly domain-specific language or multi-part queries that may involve nuanced terminology, and in sum, ensures that the embedding engine application 106 is equipped to embed these chunks in a way that reflects the true intent of the user query.

In any case, at step 216, method 200a may include embedding the user query, e.g., via the embedding engine application 106. For example, if chunk overlap was applied, the embedding process may operate on overlapping chunks. Otherwise, the tokenized query may be embedded as a single unit. The embedding engine application 106, utilizing the embedding processing module 112—whether processed as overlapping chunks or as a single tokenized unit—into a high-dimensional vector representation. The outputted embeddings may capture semantic meaning of the query, allowing the similarity search module 114 to perform meaningful comparison between the query and the stored corpus embeddings during the similarity search. This transformation enables the search and retrieval of corpus embeddings based on the complex semantic and/or other content of the embeddings, rather than simple keyword matching of the query to individual words contained in the corpus embeddings.

Embedding the query at step 216 may leverage pre-trained models that have been trained on large text corpora, enabling the system to generalize across a wide variety of query types. For example, the embedding engine application 106, utilizing the embedding processing module 112, may leverage pre-trained models may be trained to understand the relationships between words, phrases, and even sentences in a variety of contexts. By embedding the preprocessed query embeddings into a high-dimensional vector, the embedding processing module 112 may create a representation of the user query that reflects its full content, including both specific terms and their contextual relationships. For example, if a user submits a query related to “the effects of climate change on marine ecosystems,” the embedding engine application 106 may generate vector representations that capture not only the individual components of the query (e.g., “climate change,” “marine ecosystems”) but also the relationships between them, such as how climate change impacts marine life.

Moving now to FIG. 2B, the method 200b generally relates to generating a response to an embedded user query via an LLM, according to an aspect. The method 200b of FIG. 2B may, for example, continue from the conclusion of the method 200a of FIG. 2A (e.g., following step 216).

The method 200b may include accessing pre-stored corpus embeddings from the vector datastore 150 at step 218. The vector datastore 150 may store pre-processed corpus embeddings derived from a corpus of documents, such as research articles, technical reports, or other text sources. Each document may be divided into smaller chunks during preprocessing, and each chunk may be embedded into a vector representation using an embedding model similar to the one used for the user query. The corpus embeddings could be preprocessed, embedded into vector form, advantageously allowing for rapid and efficient retrieval. Furthermore, the corpus embeddings could be indexed with a semantic index to allow efficient similarity searches based on the vector representation of the query, in such a way that the similarity search module 114 may compare the embeddings with the query embeddings during a similarity search, as shown supra.

At step 220, the method 200b may include performing a similarity search to identify the most relevant document chunks from a vector datastore, based on their embeddings. For example, the similarity search module 114 may search the vector datastore 150 by comparing the vectorized query embedding against the corpus embeddings stored in the vector datastore 150. The similarity search module 114 may use similarity metrics (e.g., cosine similarity or Euclidean distance), to measure the semantic similarity between the query embedding and the corpus embeddings, enabling the ranking and retrieval of a subset most relevant document chunks based on the user query, focusing on content that provides the best contextual match. By retrieving only relevant portions of documents rather than entire documents, the similarity search may reduce irrelevant information in the results and improve the relevance of the output. Relevant document chunks may for example correspond to text from one or more documents, and/or may correspond to multi-modal content, e.g., text in combination with one or more of an image, audio, video, etc.

During this process, the query vectorizing module 140 may convert the user query into a vectorized form suitable for comparison, while the similarity scoring module 142 may rank the corpus embeddings based on their relevance to the query. At decision 222, the method 200b includes determining whether sufficient relevant corpus embeddings have been retrieved (e.g., via the embedding engine application 106). If, for example, the embedding engine application 106 finds that insufficient relevant corpus embeddings have been retrieved, the method 200b may, for example, include returning an indicative message to a user and/or retrying the similarity search with adjusted parameters to identify additional relevant corpus embeddings.

In an embodiment, the similarity search module 114 may identify the corpus embeddings that most closely match the content of the user query, and retrieve the corpus embeddings for further processing, e.g., via the retriever application 138. To determine which corpus embeddings most closely match the user query, for example, the similarity scoring module 142 may assign a semantic similarity score to each corpus embedding based on its relevance to the query embedding. The semantic similarity score may be derived from various metrics, including cosine similarity, Euclidean distance, and/or other suitable vector-based similarity measures. In addition to the semantic similarity score, the similarity scoring module 142 may account for other factors (e.g., recency of the document, with more recent documents being favored, or alternatively, the authority of the document's source, where documents from highly regarded publications or reputable sources are ranked higher). By accounting for both the semantic similarity score and other criteria, the similarity search module 114, in conjunction with other components of KPD 102, may advantageously provide users with information that is not only relevant, but trustworthy and relevant (i.e., contextually aligned with content of their query). In any case, the similarity search ensures that the retriever application 138 is not limited to retrieving corpus embeddings that merely contain specific keywords, but instead focuses on corpus embeddings that conceptually align with the intent of the user query. For example, if user query pertains to “neural networks for image recognition,” the retriever application 138 may retrieve corpus embeddings that discuss both neural networks and image recognition in a relevant context, even if the exact wording does not match the user query. This similarity search advantageously enhances the relevance and precision of the retrieved information, ensuring that the user may be presented with documents that best correspond to the semantic meaning of their query.

At step 224, once the relevant corpus embeddings have been retrieved, the similarity scoring module 142, may, for example, rank the retrieved corpus embeddings based on their relevance to the user query. The result retrieving module 144 may then retrieve the most relevant document chunks from the subset of relevant embeddings.

Once scored, at step 224, a subset of the top-ranked corpus embeddings may be selected and passed to the retriever application 138. For example, the retriever application 138 may further refine this subset to identify the corpus embeddings most relevant to the user query from among the generated plurality of initially generated corpus embeddings. For example, the retriever application 138 may orchestrate this ranking process, and may apply additional, custom scoring algorithms tailored to the specific needs or requirements of the query or the domain in question. The retriever application 138 apply additional ranking criteria, such as prioritizing more recent documents or those from authoritative sources. The retrieved corpus embeddings may serve as the basis for generating the response for output to the user, ensuring use of only the most relevant and high-quality information available. For example, in consideration of the fast-evolving field to which user queries may relate (e.g., AI), the retriever application 138 might prioritize more recent studies or papers. For a historical inquiry, on the other hand, the retriever application may prioritize authoritative sources with well-established information. The similarity scoring module 142 may work in conjunction with these custom criteria to deliver the most relevant information.

Additionally, the KPD 102 may utilize the model management module 130 to ensure that the most up-to-date versions of LLM models are employed to interpret and process the retrieved corpus embeddings. For example, the model management module 130 may monitor and update models to adapt to changes in the underlying document corpus or shifts in query patterns. If necessary, the model training module 128 can be invoked to fine-tune the models based on new data, ensuring that the retrieval and ranking processes remain current and relevant. This iterative refinement ensures that the model management module 130 to support the retriever application 138 in retrieving and ranking documents in a manner that effectively aligns with the user's needs.

After the user query has been processed, tokenized, and embedded, and the retriever application 138 has identified the relevant corpus embeddings from the datastore, the method 200b may proceed to step 226, which involves generating a coherent and meaningful response for the user. For example, the retriever application 138 may transmit these corpus embeddings to the LLM engine application 120, which may synthesize the retrieved embeddings into a structured response.

At step 226, The LLM engine application 120 may synthesize the retrieved corpus embeddings along with the original user query to generate a coherent and structured natural language response. The LLM engine application 120 may be pre-trained on large datasets, allowing it to understand and process the context provided by the corpus embeddings and formulate a coherent and accurate response. In generating the response, the LLM engine application 120 may incorporate its internal knowledge to supplement any gaps in the retrieved information, thereby yielding a well-rounded response to the query.

The LLM engine application 120 may operate using a pre-trained model trained on to large datasets, enabling it to generate responses that are both contextually accurate and comprehensive. By synthesizing information from the ranked document chunks, the LLM engine application 120 may ensure that the generated response addresses all relevant aspects of the query. For example, if the user query pertains to “the impact of climate change on marine ecosystems,” the LLM engine application 120 could synthesize and generate a response that integrates information from various retrieved corpus embeddings to provide a well-rounded explanation, covering the most pertinent research and findings in the field.

In an embodiment, the token manager module 126 may regulate that the language model within the LLM engine application 120 complies with any token or character limits that might be in place, such as those commonly imposed in conversational AI platforms. For example, the token manager module 126 may optimize how the input/output processing of the LLM engine application 120, ensuring that the LLM engine application 120 remains within these limits, without sacrificing completeness or informativeness response. Furthermore, this token optimization helps deliver responses that are both thorough and concise, even when token limits are enforced.

In some embodiments, the LLM engine application 120 may supplement the information retrieved from corpus embeddings, and in any gaps that may exist in the retrieved document chunks. For example, if the retrieved corpus embeddings do not fully address the user query, the LLM engine application 120 may use its pre-trained knowledge data to provide additional context or clarification. This capability allows the LLM engine application 120 to generate a response even when the retrieved information is incomplete, ensuring that the user receives a comprehensive answer.

Moving to FIG. 2C, the example method 200c generally relates to providing a validating a generated response to a user query, according to an aspect. The method 200c of FIG. 2C may, for example, proceed from the conclusion of the method 200b of FIG. 2B (e.g., from step 226, where a response to the user query is generated), which may itself proceed from the conclusion of the method 200a of FIG. 2A.

At a step 228, upon obtaining a generated response to a user query (e.g., according to steps of FIGS. 2A and/or 2B), citation generating module 146 may identify, extract, and append relevant information points (e.g., citations, and/or other information points described herein such as excerpts, images, data tables, some combination thereof, etc.) to the relevant document chunks retrieved from the vector datastore 150 during a similarity search process (e.g., as described with respect to FIG. 2B). For example, at step 228, the citation generating module 146 may operate by associating specific portions of the final response with the corresponding document chunks that were retrieved and ranked in the retriever application 138. When the LLM engine application 120 synthesizes the retrieved document chunks into a structured response, the citation generating module 146 tracks which chunks contributed to each part of the response.

Once the response is generated, at step 228, the citation generating module 146 may append relevant information points to the relevant portions of the response. At step 228, the citation generating module 146 may use several internal processes to track which corpus embeddings contributed to the generated response. For example, as a context manager module 124 integrates multiple corpus embeddings into the generated response, the citation generating module 146 may monitor which embeddings are selected and synthesized by the LLM engine application 120. Each corpus embedding, stored in the vector datastore 150, retains metadata (extracted via the metadata extracting module 116) that includes details such as document title, author, publication date, and source URL. The citation generating module 146 may access this metadata to accurately link each portion of the response back to its original source.

In an embodiment, the citation generating module 146 may create a list of retrieved data from the vector datastore 150, and cross-reference the list with the records in the auxiliary datastore 152. When relevant information point matches are identified, the citation generating module 146 may append these references inline within the response and/or as a list appended at the end of the generated response.

In one embodiment, the citation generating module 146 processes both the original document chunks and the relevant information point list simultaneously, merging the document chunks and relevant information point list before sending the merged data to the LLM engine application 120 for response generation. In a different embodiment, the relevant information point list is processed separately from the document chunks, with the citation generating module 146 appending the relevant information points after the response has been generated.

In one embodiment, the citation generating module 146 may append inline relevant information points within the body of the response. For instance, if a user query involves technical documentation on “machine learning model optimization,” and a portion of the response references specific findings from an academic paper, the citation generating module 146 may include an inline citation (e.g., “[1]”) linked to the original source. Additionally or alternatively to inline relevant information points, the citation generating module 146 may compile a list of relevant information points at the end of the response. This list may include the relevant metadata extracted from each corpus embedding—such as document title, author, publication date, and source URL.

In cases where multiple document chunks contribute to a single portion of the response, the citation generating module 146 may include multiple references. For example, if the LLM engine application 120 synthesizes information from two or more documents to generate a comprehensive answer, the citation generating module 146 may include all relevant information points at that point in the response (e.g., all relevant information points satisfying at least a particular threshold score of relevance), allowing the user to trace the information back to multiple sources.

The citation generating module 146, in embodiments, may also format relevant information points based on the specifications of the user or of the model management module 130. For instance, depending on the context (e.g., academic, technical, or legal), the citation generating module 146 may generate citations in formats such as APA, MLA, IEEE, or other styles. This ensures that the generated response is tailored to the user's needs, while maintaining proper attribution of sources.

Before transmitting the response to the user, the method 200c may include a validation step 230 to ensure the accuracy and reliability of the information provided to the user. For example, a model evaluation module of the KPD 102 may validate the output of the LLM engine application 120 by cross-referencing the response with the retrieved corpus embeddings to verify that the response is consistent with the original source material. Validation step 230 ensures that the generated response is aligned with the information retrieved from the document chunks and minimizes the risk of hallucinations—where the model may generate plausible-sounding but inaccurate or fabricated information. By validating the response, the model evaluation module may yield a higher level of trust and accuracy in the information provided to the user.

At decision 232, the model management module 130 assesses whether the generated response is accurate and consistent. For example, if any hallucinates and inconsistencies are found, the LLM engine application 120 may modify and re-generate a response. A modification step 234 allows the response to be refined as needed to ensure that it meets the standards of accuracy and alignment with the retrieved corpus embeddings. After modification, the response is looped back to the validation step at 230, where it undergoes a re-evaluation to confirm that all issues have been resolved.

Once the response has been validated at step(s) 230 and 232, method 200c may include, at step 236 transmitting the validated response to the user through the user interface layer 178. This transmission may be formatted according to the user platform, whether it be a web-based application, mobile app, or another medium, ensuring that the response is not only accurate and well-cited but also readily accessible and easy to interpret for the user.

In embodiments, the method 200c may also include the use of a caching application 158 to store frequently accessed queries and their corresponding responses. caching application 158 may advantageously reduce latency in future interactions by allowing the KPD 102 to retrieve pre-generated responses to common queries from the cache, rather than recalculating them each time. This not only enhances the efficiency of the KPD 102, but also improves response times, particularly for high-traffic environments or when dealing with recurring user queries.

In embodiments, the DBR application 160 may ensure that all relevant data, including both the validated response and any associated query data, is securely stored. This storage mechanism allows for reliable recovery in the event of failures, maintaining the integrity and reliability of the overall knowledge processing device. The DBR application 160 may use replication techniques to store data across multiple servers or cloud-based systems, ensuring that the KPD 102 remains resilient against data loss or downtime.

Still additionally or alternatively, in embodiments, the method 200 may further include steps for storing query and response data to continuously improve system performance. The auxiliary datastore 152 may store user queries, their corresponding responses, and interaction patterns (e.g., query refinements, follow-up questions). The historical data in the auxiliary datastore 152 may be used to train and optimize the underlying ML models of the LLM engine application 120, allowing the LLM engine application 120 to become more efficient and accurate over time. For instance, if the model training module 128 detects that certain types of queries frequently require additional refinement or clarification, this data may be used to proactively adjust how similar queries are handled in the future.

The model management module 130 may use this stored data in the auxiliary datastore 152 to retrain or fine-tune the LLM engine application 120 and/or related models, ensuring that they remain aligned with evolving user needs and query patterns. Over time, the LLM engine application 120 may become better at anticipating user queries and providing more precise, contextually accurate responses. Additionally, the stored data may help identify areas where the LLM engine application 120 may need improvement, such as cases where validation steps frequently detect inconsistencies or inaccuracies in the generated responses. These insights can be used to enhance the performance of the LLM engine application 120, ultimately improving both the speed and accuracy of responses. By storing this data, the model training module 128 also ensures that the LLM engine application 120 can maintain a continuous learning loop, allowing it to self-optimize based on real-world usage patterns. This capacity for continuous improvement not only ensures that the LLM engine application 120 remains relevant and effective but also enhances user satisfaction by consistently delivering high-quality, reliable responses.

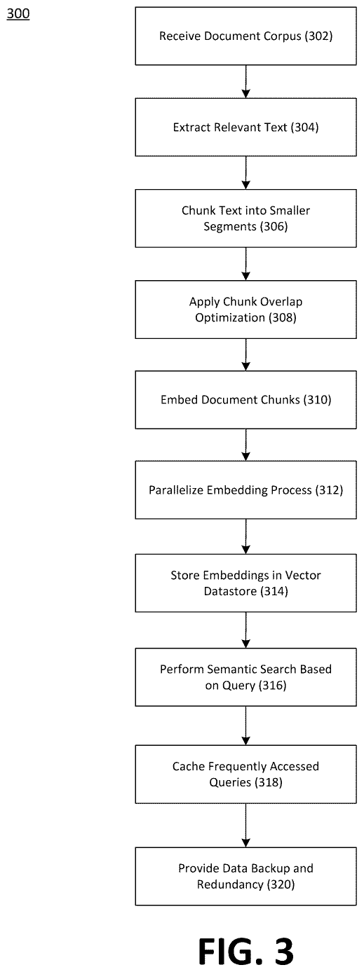

Each of the methods 200a, 200b, and 200c may include additional, fewer, and/or alternate actions, in various embodiments. For example, in embodiments, actions of the methods 200a, 200b, and/or 200c may be substituted and/or augmented with actions of the methods of FIGS. 3, 4, 5, and/or 6.

Referring now to FIG. 3, an example method 300 generally relates to embedding documents from a corpus and organizing the embedded documents in a datastore for future retrieval, according to an aspect. At a high level, method 300 involves processing an input corpus of document(s), extracting relevant text, chunking the text into smaller segments, embedding these chunks into vector representations, and storing the resulting embeddings in a semantic index within a datastore. More particularly, method 300 may employ open-source tools and parallel processing to optimize both the embedding and storage processes. For example, the document loading module 108 may ingest documents from the corpus, while the text chunking module 110 divides the text into appropriate segments, ensuring each chunk is sized optimally for embedding. These chunks may then be embedded by the embedding processing module 112, which generates vector representations that capture the semantic meaning of each chunk. Once embedded, the resulting vector representations may be stored in the vector datastore 150, accessible through the vector datastore interface application 148. By organizing the embeddings in a semantic index, method 300 enables efficient similarity-based retrieval, allowing relevant document chunks to be quickly identified and retrieved during later stages of processing. This method may be implemented by one or more processors executing computer-readable instructions stored in one or more memories within the computing system, as described in FIG. 1.

At step 302, method 300 may include receiving and loading the document corpus locally. For example, at step 302, the document loading module 108 may obtain and ingest various forms of unstructured document corpora (e.g., research papers, technical documents, internal reports, source code files, and other text sources) which may be sourced from local or remote sources (e.g., databases, libraries, code repositories, or research repositories).

In embodiments where the document corpus includes source code files, the document loading module 108 may parse the source code files to extract code symbols including functions, classes, methods, variables, type definitions, and other programmatic constructs. Each extracted code symbol may be associated with metadata including file path, line number, scope information, parameter types, return types, and documentation strings.

To manage the diverse formats commonly found in a document corpus (e.g., PDFs, word files, plain text, programming language source files, etc.), the document loading module 108 may employ open-source libraries (e.g., LangChan) to standardize and convert the corpus into standard, consistent format suitable for further downstream processing. In some embodiments, the document loading module 108 may implement multi-threading, expediting the ingestion phase and optimizing efficiency of the step 302. By preparing the document corpus in such a standardized manner, method 300 enables subsequent stages (e.g., content extraction, text chunking) to operate consistently across different corpus formats. Step 302 ensures that each document is accessible and ready for further processing by components (e.g., the text chunking module 110, embedding processing module 112, etc.).

At step 304, once the corpus or corpora are loaded, the embedding processing module 112 may extract the relevant content from each corpora (e.g., textual content, image/video content, audio content, multi-modal content, etc.). In some embodiments, if the extracted content is to only include semantic content, the embedding processing module 112 may identify and remove non-textual elements (e.g., images, tables, or metadata) which may not contribute to the subsequent semantic embedding process. By focusing on the main body of text from each corpus, the embedding processing module 112 ensures that only the textual content from each corpus is preserved, while discarding non-textual components. Extraction step may optimize each corpus for the subsequent chunking and embedding phases, ensuring that the text is clean, consistent, and suitable for processing by the text chunking module 110. By isolating the core text, the embedding processing module 112 helps streamline the chunking process and enhances the quality and relevance of the generated embeddings in later steps.

At step 306, the text chunking module 110 may partition the extracted content (e.g., textual, image/video, audio, and/or multi-modal content) into smaller, user-defined chunks, wherein adjacent document chunks may share overlapping content to preserve contextual coherence between successive segments. For example, at step 306, the text chunking module 110 may divide the content of the chunks based on a specific number of sentences, words, or tokens per chunk (and/or based on portions of images, videos, audio files, and/or other content, in various embodiments). Chunking step facilitates optimization the embedding and retrieval processes, as embedding models often have constraints on the size of the input text they are capable of processing simultaneously. By splitting the corpus into smaller chunks, with adjacent chunks sharing overlapping portions of content, the text chunking module 110 may enable each segment to retain sufficient context for meaningful embeddings while staying within the input constraints of the embedding model.

The chunking process might be further adjusted based on the specific characteristics of the input text, with a focus on ensuring that each chunk remains semantically coherent. For example, chunking allows for more granular information retrieval, as individual sections of a document can be retrieved based on their relevance to a query, rather than retrieving entire documents that may contain irrelevant information.

At step 308, in some implementations, the chunk overlap optimizing module 118 may apply an overlapping strategy, where adjacent chunks share portion(s) of common text. For example, at step 308, the chunk overlap optimizing module 118 may create overlapping segments between chunks, ensuring that important semantic relationships between words or phrases are preserved across chunk boundaries. This overlapping technique may mitigate the loss of context that might occur if the text were split strictly by sentence or token limits, which can be especially advantageous when dealing with complex or interrelated concepts. The degree of overlap may be configured based upon the characteristics of the document corpus and the embedding model's constraints

The techniques of step 308 can be understood, for instance, by considering a scientific document discussing “neural network training and optimization.” Without chunk overlap, the phrase “neural network training” might appear in one chunk, while “optimization” may appear in a different chunk, potentially disconnecting these related concepts. By introducing overlap, the chunk overlap optimizing module 118 helps ensure that both “neural network training” and “optimization” concepts appear in both chunks, remaining connected across chunk boundaries, thus preserving the continuity, and overall meaning of the text. This approach allows the embedding model to capture the full semantic context when processing each chunk, resulting in more accurate and coherent embeddings.

In some embodiments, the text chunking module 110 may partition documents with overlapping chunks, wherein adjacent documents chunks share a portion of common content. This overlapping strategy may further preserve contextual relationships between successive text segments. For example, referring back to the scientific document discussing “neural network training and optimization,” if a first chunk ends with the sentence “Neural networks require optimization,” and a second chunk begins with “Optimization techniques include gradient descent,” the overlap may ensure that both “optimization” concepts remain connected across chunk boundaries. By maintaining overlap between adjacent chunks, the embedding processing module 112 may generate embeddings that capture semantic relationships that span chunk boundaries, thereby improving the quality and coherence of retrieved information during query processing.

Additionally, in embodiments, the chunk overlapping techniques can be fine-tuned based on the specific needs of the corpus and the embedding model's constraints. For example, in a corpus with dense technical jargon or complex explanations, a larger overlap may be applied to ensure that the necessary context is preserved across chunks. This overlapping technique enables the embedding and retrieval process to retain a more comprehensive understanding of the text, which can improve the accuracy of information retrieval and the relevance of responses generated from these embeddings.

At step 310, once the text has been chunked, method 300 may then proceed to embed each document chunk. For example, at step 310, the embedding processing module 112 may transform each chunk of text into a high-dimensional vector representation (e.g., corpus embedding). This embedding process captures the semantic meaning of the text, encoding complex relationships between words and phrases within a numerical format that the KPD 102 (e.g., similarity search module 114) can subsequently leverage for later comparison and retrieval. These corpus embeddings enable semantic comparisons between user queries and stored document chunks during the retrieval process (as discussed above). The embedding process may leverage models pre-trained on large text corpora, such as those listed on the Massive Text Embedding Benchmark Leaderboard (MTEB), which provides a variety of models optimized for capturing semantic meaning across diverse text domains. By utilizing these pre-trained models, the embedding processing module 112 can ensure that the embeddings are generalizable and capable of accurately representing a wide range of topics within the document corpus. Each corpus embedding may represent semantic content of a corresponding document chunk, capturing the meaning and context of the text in a numerical format suitable for similarity-based comparisons.

To handle large document corpora efficiently, method 300 may integrate a distributed processing framework (e.g., Ray framework) at step 312 to parallelize the embedding computations across multiple GPU or CPUs. For example, at step 312, the embedding processing module 112 may employ a distributed framework (e.g., Ray Framework), to divide the embedding tasks across multiple processing units. Parallelization may advantageously allow the KPD 102 to process large volumes of text simultaneously, significantly reducing the overall processing time. In addition to distributed frameworks, the embedding processing module 112 may utilize specialized libraries (e.g., ActorPoolStrategy) to manage and coordinate the parallelization of the embedding process (e.g., using the load balancer application 154).

The output of the embedding process may include or consist of a series of encoded vectors or arrays of numbers, wherein each may capture the semantic meaning and context of an input chunk. These encoded vectors may enable the LLM engine application 120 (e.g., specifically, the context manager module 124) to better understand relationships between different sections of text, facilitating more accurate semantic comparisons with future user queries. For instance, if a user query references specific concepts like “renewable energy advancements,” these embeddings may enable the KPD 102 to match relevant chunks of text from across the document corpus, even if the exact wording differs. By capturing the broader semantic context, these embeddings enhance the LLM engine application 120's ability to retrieve and synthesize information that aligns with the user's intent, ensuring both precision and relevance during the retrieval phase.

At step 314, once the document chunks are embedded, the vector datastore 150 may store the resulting embeddings, organized within a semantic index to facilitate efficient retrieval and semantic search operations. For example, at step 314, the vector datastore 150 may function as a long-term memory for the LLM, allowing the LLM engine application 120 to efficient retrieval of document chunks during query processing based on their content. The vector datastore interface application 148 may manage the interaction between the embedding processing module 112 and the vector datastore 150, ensuring that the embeddings are indexed and stored in a structured format. This structured storage may enhance the speed and accuracy of responses to user queries. Various open-source databases (e.g., Chroma, Faiss, Qdrant, or Vespa), may be employed to manage this vectorized data, as these systems as these systems are optimized for handling high-dimensional vector data and performing similarity searches based on content. The semantic index may provide the system with fast and accurate querying capabilities, as these stored embeddings can advantageously be queried based on their semantic similarity to user queries, enabling the KPD 102 to retrieve the most relevant document chunks for future processing, and subsequently respond with a more well-rounded answer, supporting higher-quality interactions with a user.

At step 316, similarly to the steps described with respect to the method 200b (e.g., decisions/steps 220, 222, and 224), the similarity search module 114 may perform a semantic search based on the user query. For example, at step 316, the similarity search module 114 may compare the query embedding against corpus embeddings stored within a semantic index in the vector datastore 150, using similarity metrics (e.g., cosine similarity or Euclidean distance) to measure semantic alignment of the query embedding and the corpus embeddings.

By ranking corpus embeddings based on their relevance to the query, the scoring module 142 and result retrieving module 144 may retrieve a subset of document chunks that best align with the intent of the query, focusing on content that provides the most contextually relevant information. This selective retrieval process may not only reduce irrelevant data but also enhance the relevance of the output, as previously discussed with respect to the method 200b of FIG. 2B.

Still additionally or alternatively, in embodiments, at step 318, the caching application 158 may store frequently accessed queries and their corresponding embeddings. As previously described with respect to the method 200c of FIG. 2C (e.g., decisions/steps 230, 232, 234, and 236), the caching application 158 may retain processed queries and their associated embeddings to minimize the need for repetitive processing. For example, if a user frequently queries submits queries related to “machine learning optimization techniques,” the caching application 158 may cache these embeddings for rapid retrieval, without needing to reprocess the entire document corpus.

Still additionally or alternatively, in embodiments, at step 320, the DBR application 160 may ensure data backup and redundancy, similarly to the data protection strategies discussed with respect to the method 200c of FIG. 2C. For example, the DBR application 160 may securely store all data, including corpus embeddings and its associated metadata, by employing replication techniques across multiple servers or cloud-based environments. Such redundancy may protect the KPD 102 by ensuring that the stored data remains accessible in the event of system failures.

The method 300 may include additional, fewer, and/or alternate actions, in various embodiments. For example, in embodiments, actions of the method 300 may be substituted and/or augmented with actions of the methods of FIGS. 2A-2C, 4, 5, and/or 6.

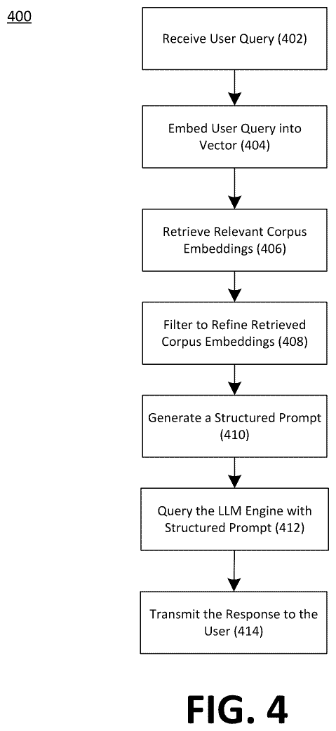

Moving now to FIG. 4, an example method 400 generally relates to generating responses to user queries using a RAG framework integrated with an LLM, according to an aspect. Method 400, at a high level, involves processing the user query, embedding the user query into a vector space, retrieving relevant corpus embeddings from a vector datastore, and synthesizing the retrieved embeddings into a structured, natural language response. Method 400 may be implemented across multiple processing units within a computing environment, enabling efficient query processing and response generation. In some embodiments, method 400 may include least three primary code constructs: (i) database loading, (ii) query similarity assessment, and (iii) response generation using the LLM, which may be performed by one or more processors executing computer-readable instructions stored in memory, allowing for coordinated handling of a user query (e.g., as described with respect to FIG. 1).

At step 402, upon receiving a user query through a user interface (e.g., user interface layer 178, which may be integrated into a client application 176 on the client device 168), KPD 102 may initiate a query similarity assessment process. For example, at step 402, the user query be received and processed by the prompt controller module 122, which may prepare the query for further processing (e.g., parsing and analyzing the structure of the user query to ensure it meets the necessary internal requirements for embedding). Once the query is processed by the prompt controller module 122, it may be transmitted to the query vectorizing module 140 for embedding.

At step 404, once the user query has been processed, the embedding processing module 112 may embed the user query using an embedding model. For example, at step 404, the embedding processing module 112 may transform the natural language query into a high-dimensional vector representation, or query embedding (e.g., comprising five, ten, twenty, or more dimensions). This embedding process may capture the semantic meaning of the user query, enabling it to be effectively compared with the pre-stored corpus embeddings stored within the vector datastore 150. The embedding processing module 112 may leverage a plurality of embedding models (e.g., BERT, GPT, Word2Vec, FastText, RoBERTa, DistilBERT, etc.) trained on large text corpora, ensuring that that the transformed user query (e.g., now a vector) may accurately reflect the context and intend behind the user's words. By converting the query into this structured, numerical format, the embedding processing module 112 enables efficient similarity-based searches within the vector datastore 150, as the query embedding can now be matched against stored corpus embeddings to identify relevant content.

At step 406, once the user query has been embedded, the retriever application 138 may retrieve a subset of corpus embeddings representing content most aligned with the user's query (e.g., most semantically aligned for semantic content, or analogously aligned for image, video, audio, and/or multi-modal content). For example, may use a parameter k to control the number of query-matching segments retrieved, where parameter k controls the breadth of retrieved data (e.g., by k defining a threshold relevance value for query-matching segments to be retrieved). As the value of k increases, a larger number of corpus embeddings may be retrieved by the retriever application 138, providing more context to the LLM engine application 120 to consider during response generation.

In certain embodiments, the retriever application 138 adjust retrieval settings based on query complexity or user preferences, adjusting the number of retrieved segments to balance processing efficiency with response comprehensiveness. By tailoring the retrieval scope in response to these factors, the retriever application 138 may balance processing efficiency with response detail, ensuring that the subsequent response generation phase incorporates sufficient context while minimizing extraneous information. Once the relevant corpus embeddings are identified and ranked, they may be transmitted to the LLM engine application 120 for synthesis into a coherent and contextually accurate response for the user.

At step 408, once the relevant corpus embeddings have been retrieved, a filtering mechanism may further refine the results (e.g., further refining the subset of corpus embeddings retrieved in step 406). For example, at step 408, the retriever application 138 may prioritize corpus embeddings based on quality indicators, such as authority, relevance, or recency, while discarding any irrelevant, duplicate, or low-confidence data. This filtering process may ensure that the corpus embeddings passed to the LLM engine application 120, and subsequent synthesized response presented to the user reflects the most pertinent and reliable data sources, improving the accuracy of the output of the filtering process.

At step 410, following the filtration process, a structured prompt may be generated to guide the LLM engine application 120 in synthesizing a response. For example, at step 410, the context manager module 124 may combine the subset of corpus embeddings (which are now filtered) with the original user query to create a structured prompt, ensuring that the LLM engine application 120 has the necessary context from both the user query and the retrieved corpus embeddings to synthesize a relevant and coherent response.

The structured prompt at this step may include elements from the user query and the subset of corpus embeddings retrieved from the vector datastore 150, formatted to optimize the LLM's understanding of the context. This structure may allow the LLM engine application 120 to consider both the user's intent and the supporting information when generating a coherent and contextually accurate response.

At step 412, the structured response may be submitted to the LLM engine application 120 to synthesize a response to the user. For example, at step 412, the LLM engine application 120 may process the structured prompt by synthesizing the original user query with the most relevant content retrieved from the corpus embeddings, to synthesize a natural language output that directly addresses the user query. This response generation process at this step leverage the pre-trained knowledge of the LLM engine application 120, as well as relevant information stored in datastores such as the vector datastore 150 and/or auxiliary datastore 152 to integrate contextual knowledge with specific retrieved content, enhancing the comprehensiveness and accuracy of the response produced via the LLM engine application. The LLM engine application 120 may combine and synthesize information from multiple corpus embeddings within the structured prompt, ensuring that the generated response is coherent, well-structured, and grounded in the most relevant content. This synthesis step allows the LLM engine application 120 to address all aspects of the user query, providing a complete and contextually accurate response.

Next, once the output has been synthesized and generated, the LLM engine application 120 may transmit the response to the user via the user interface layer 178 at step 414. For example, the LLM engine application 120 may transmit the response to the user via the same interface that initially received the user query, ensuring seamless communication between the KPD 102 and the client device 168 (e.g., a mobile device, tablet, or computer).

To facilitate this communication, the synthesized response may be transmitted from the KPD 102 (e.g., the LLM engine application 120) over the network 182 via the NIC 180. The NIC 180 ensures that the response is securely and efficiently relayed from the KPD 102 to the client device 168, enabling seamless interaction across different network environments.

The user interface layer 178 on the client device 168 may then display the response in a format optimized for the client application 176, providing the user with clear and accessible information. Additionally, the response may include relevant information points appended by the citation generating module 146, referencing specific document chunks that contributed to the answer. These relevant information points may be derived from metadata stored in the vector datastore 150 and auxiliary datastore 152, providing the user with transparency and traceability of the information sources. This structured presentation allows the user to verify the origins of the information provided, thereby enhancing the credibility and reliability of the response.

The method 400 may include additional, fewer, and/or alternate actions, in various embodiments. For example, in embodiments, actions of the method 400 may be substituted and/or augmented with actions of the methods of FIGS. 2A-2C, 3, 5, and/or 6.

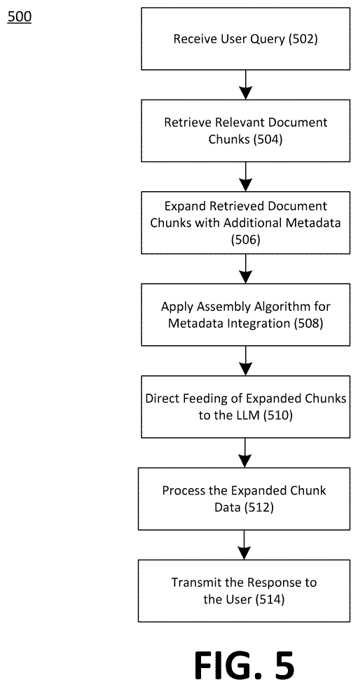

Referring now to FIG. 5, an example method 500 generally relates to providing a user query using document chunks and metadata associated therewith. More particularly, though, the method 500 may assist in enhancing the accuracy and relevance of the responses generated by an LLM by leveraging the additional metadata from expanded corpus embeddings. The method 500 may generally involve retrieving relevant corpus embeddings, applying an assembly algorithm and/or expansion of retrieved document chunks with associated metadata, and feeding this expanded data back into the LLM for more informed responses. Specifically, method 500 may involve retrieving initial corpus embeddings related to a user query, enriching these embeddings with additional metadata fields (e.g., author information, publication date, topic tags, or summaries), and feeding this expanding dataset into the LLM engine application 120. This expanded metadata access may allow an LLM to operate with a more comprehensive understanding of the content, including key contextual elements that may not be immediately apparent from the text of a corpora alone. By leveraging metadata from sources such as the vector datastore and/or auxiliary datastore 152, the LLM engine application 120 can synthesize responses that reflect a deeper alignment with the intent of the user query, especially for complex queries requiring in-depth and nuanced answers. The method 500 can be implemented by one or more processors executing computer-readable instructions stored on one or more memories of a computing system (e.g., as described with respect to FIG. 1).

At step 502, method 500 may begin with receiving a user query. For example, at step 502, a user may a query through an interface (e.g., user interface layer 178), which may be accessed via the client application 176 on a client device 168. Upon receiving the query, the prompt controller module 122 may, for example, process the query to generate a query embedding (as described supra). This embedding captures the semantic meaning of the user's input and may be used in subsequent steps for document retrieval and metadata enhancement. By converting the query into an embedding, the prompt controller module 122 may facilitate similarity-based comparisons with corpus embeddings stored in the vector datastore 150.

At step 504, similarity search module 114 may retrieve a subset of relevant corpus embeddings from a datastore based on the query embedding (step 504). For example, at step 504, the similarity search module 114 may compare the query embedding against stored corpus embeddings organized in a semantic index within the vector datastore 150, and may identify those that are most semantically aligned with the user's query. This retrieval process may use similarity metrics (e.g., cosine similarity, Euclidean distance) to rank corpus embeddings by relevance to the user query, as discussed with respect to step 406 in the method 400.

As discussed previously with respect to step 406 of FIG. 4, the retrieval process of step 504 may be influenced by a parameter k, to control the number of corpus embeddings returned. Increasing k allows the similarity search module 114 to a broader set of corpus embeddings, which may provide for broader context for downstream processes. For example, by increasing k, the similarity search module 114 can access a more extensive range of relevant document chunks, which may enhance the response generation phase by supplying additional context for interpretation and synthesis.

A higher parameter k value may enable for expanded retrieval engages several additional modules, including the context manager module 124 for structuring content, the metadata extracting module 116 for enriching information, and the LLM engine application 120 for synthesizing an informed response. Together, these modules ensure that the response generation process is both comprehensive and contextually grounded, ultimately enhancing the quality and relevance of the information provided to the user.

Conversely, using a smaller parameter k value reduces the number of corpus embeddings, which may be advantageous in certain scenarios. For instance, when the query is straightforward or highly specific, retrieving fewer document chunks can help streamline processing, reduce computational load, and minimize response latency. A smaller k value may be particularly suitable for high-traffic environments or for time-sensitive applications where rapid response times are prioritized. Additionally, limiting the retrieval scope with a smaller k helps to filter out extraneous information, focusing the response generation process on the most immediately relevant content.

In any case, the similarity search module 114 and related components, such as the retriever application 138 and the context manager module 124, can adjust the retrieval settings based on the complexity of the user query or specific user preferences, as discussed with respect to step 406 of the method 400 of FIG. 4. This flexibility in adjusting k may allow the method 500 to balance between providing comprehensive context and maintaining processing efficiency, ultimately tailoring the response to meet the needs of the user and the performance requirements of the KPD 102.

Once the subset of corpus embeddings has been retrieved, at step 506, method 500 may include expanding the retrieved corpus embeddings by extracting additional metadata and contextual information from the input corpora. For example, at step 506, the context manager module 124 may access the metadata extracting module 116 to retrieve supplementary sections or associated metadata from the vector datastore and/or auxiliary datastore 152. This metadata may include document summaries, publication dates, topic tags, and author information, which may enrich the initial subset of retrieved corpus embeddings by providing more contextual information. Through the incorporation of expanded metadata, the LLM engine application 120 may gain access to a broader and more nuanced dataset, supporting it in generating responses that are both contextually rich and highly accurate.

At the step 506, method 500 may incorporate any of various alternatives for handling the expanded corpus embeddings, contingent on the processing requirements and available resources. In one embodiment, method 500 may leverage an assembly algorithm at step 508. For example, the context manager module 124 may use an assembly algorithm to append the additional metadata and relevant information point lists (e.g., retrieved by the metadata extracting module 116 at step 506) to the original corpus embeddings. This consolidated dataset may then be prepared for transmission to the LLM engine application 120 for response synthesis. The assembly algorithm can then carefully combine relevant parts of the expanded document chunks while reducing the presence of unnecessary or redundant information.

Alternatively, at step 510, method 500 may handle the expanded corpus embeddings data to the LLM without additional assembly (e.g., transmitting them directly to the LLM engine application 120 without further assembly). In this configuration, the expanded embeddings may be fed directly into the LLM engine application 120, allowing the model to autonomously process and organize the broader dataset. This direct feeding approach can reduce preprocessing time by eliminating the assembly phase; however, it may impose a greater load computational load on the LLM engine application 120, as the model will be responsible for managing and interpreting the expanded dataset on its own.

In any case, the decision between using an assembly algorithm or directly feeding the expanded data to the LLM engine application 120 may be based on available system resources, user query complexity, and/or resource requirements. In some cases, the NIC 180 may also operate to ensure efficient data transmission to the client application 176 if the response to be synthesized is particularly data-intensive.

At step 512, method 500 may involve processing the expanded document chunk data within the LLM engine application 120. For example, after the expanded document chunks have been prepared through an assembly algorithm and/or direct feeding (as discussed in steps 508 and 510, respectively), the expanded chunks can be input into the LLM engine application 120. At this stage, the LLM engine application 120 may synthesize the structured data along with the original user query, generating a natural language response that aligns with the query's intent and contextual requirements. As described with respect to step 226 of the method 200b of FIG. 2B, the LLM engine application 120 leverages both the retrieved corpus embeddings and its pre-trained knowledge to formulate a coherent response.

At step 514, method 500 may include a quality control and validation process to ensure the relevance and accuracy of the expanded corpus embeddings before the expanded corpus embeddings are provided to the LLM engine application 120. For example, as described in the validation step 230 of the method 200c of FIG. 2C, a model evaluation module may cross-reference the expanded embeddings with their original source material to verify consistency and reduce the risk of hallucinations. Further similar to decision 232 of the method 200c, if inconsistencies and/or inaccuracies are detected within the expanded embeddings, the model management module 130 may trigger a refinement process, wherein the embeddings may be further filtered and/or modified to align with accuracy thresholds, ensuring that only verified and contextually relevant data is included. Following any necessary adjustments, the validated embeddings may undergo a final quality check before proceeding to the response generation phase handled by the LLM engine application 120.

The method 500 may conclude with returning the generated response to the user at step 514. Once the LLM engine application 120 synthesizes the response, the response may be transmitted to the user through the same interface used to submit the query, such as the user interface layer 178, which operates in conjunction with the client application 176 on a client device 168. Similar to the relevant information point generation process described with respect to step 228 of the method 200c, the citation generating module 146 may append references to the relevant document chunks or additional metadata, allowing the user to trace the information back to its original source. This transparency enhances the response by providing traceability and credibility, ensuring that users can verify the sources contributing to the answer.

The method 500 may include additional, fewer, and/or alternate actions, in various embodiments. For example, in embodiments, actions of the method 500 may be substituted and/or augmented with actions of the methods of FIGS. 2A-2C, 3, 4, and/or 6.

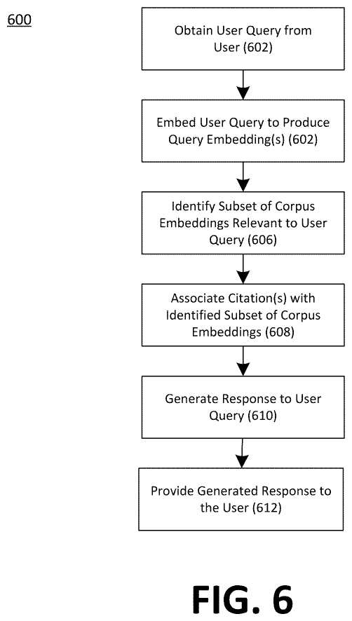

Moving now to FIG. 6, still another example computer-implemented method is provided, according to an aspect. In embodiments, the method may be performed via components of the computing environment 100 of FIG. 1, and/or another suitable computer component(s). In embodiments, one or more non-transitory memories or one or more non-transitory computer readable media store instructions that, when executed via one or more processors, cause one or more computers to perform actions of the method 600.

At step 602, the method 600 includes obtaining a user query from a user (e.g., via a client application executing on a client device, over one or more networks).

At step 604, the method 600 further includes embedding the user query to generate one or more query embeddings (e.g., vector embeddings, such as a high-dimensional vector embedding described herein).

The method 600 still further includes, at step 606, identifying, from a plurality of corpus embeddings, representing content (e.g., semantic content, image/video content, audio content, and/or multi-modal content) of one or more documents in a document corpus (which may include exclusively text, or alternatively, text in combination with one or more of image, videos, audio files, etc.), a subset of one or more corpus embeddings relevant to the user query. More particularly, the identifying may be based on comparison of the one or more query embeddings to the plurality of corpus embeddings (e.g., vector comparisons, including any suitable comparison technique described herein).

The method 600 still yet further includes, at step 608, associating one or more relevant information points with the retrieved subset of corpus embeddings. The one or more relevant information points may indicate one or more locations in the document corpus corresponding to the retrieved subset of corpus embeddings (e.g., locations where referenced information for a response is found).

At step 610, the method 600 further includes generating a response to the user query. More particularly, the response to the user query may be based on the identified subset of corpus embeddings and/or the one or more relevant information points.

At step 612, the method 600 still further includes providing the generated response to the user (e.g., by transmitting the response to a client device over one or more networks, and/or by otherwise causing the response to be displayed via the client device and/or another suitable computing device).

The method 600 may include additional, fewer, and/or alternate actions, in various embodiments. For example, in embodiments, actions of the method 600 may be substituted and/or augmented with actions of the methods of FIGS. 2A-2C, 3, 4, and/or 5.

### Example LLM Inputs and Outputs

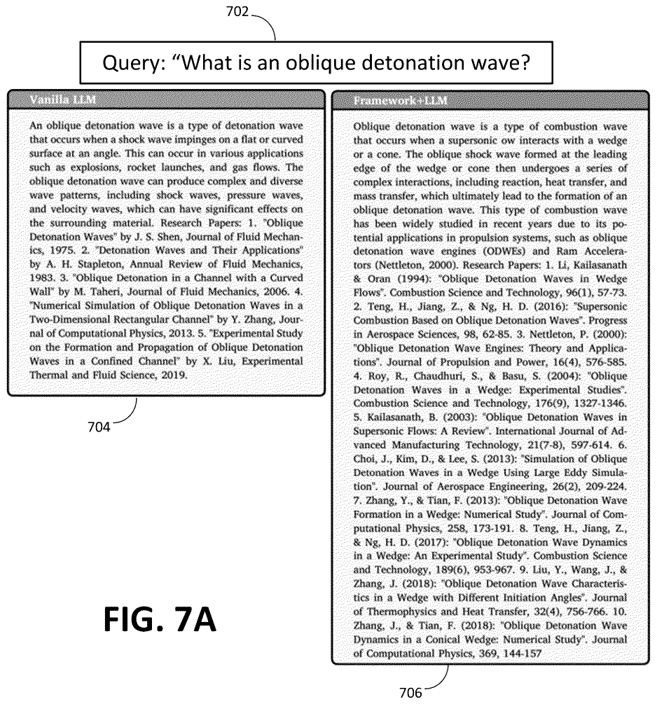

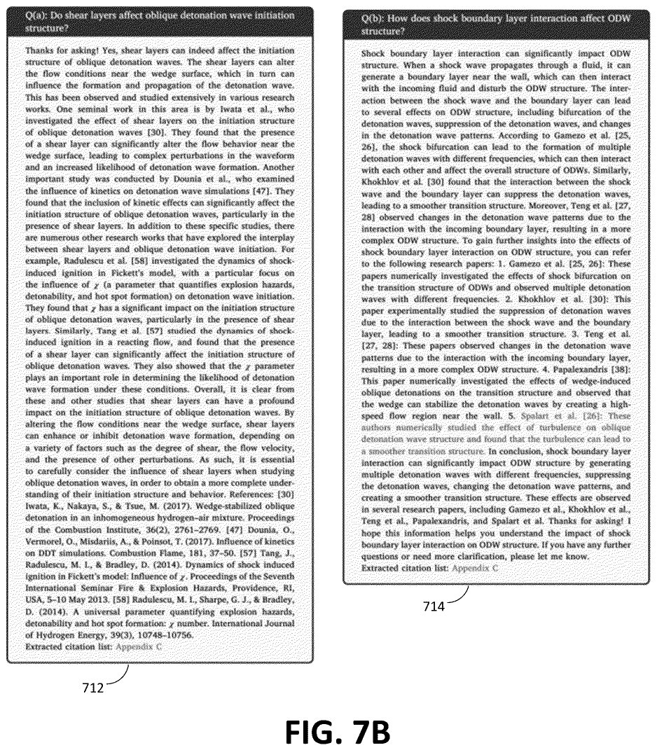

FIGS. 7A and 7B depict example responses generated to user queries to one or more LLMs, in the field of combustion science. Particularly, each of FIGS. 7A and 7B illustrates two responses to one or more user queries to one or more LLMs, where differences between the two responses demonstrate advantages of various techniques described in this disclosure. The user queries and prompts described herein may be produced, for example, via the environment 100 described with respect to FIG. 1 (i.e., at least a portion thereof).

First referring to FIG. 7A, a first user query 702 asks for a definition of an “oblique detonation wave,” a concept in the field of combustion science. In a left panel, a first example response 704 from an LLM (“Vanilla LLM”) provides a definition of the oblique detonation wave, along with indications of four reference documents where information about the oblique detonation wave may presumably be found. In a right panel, however, LLM techniques are augmented with relevant information point and/or validation frameworks of this disclosure (“Framework+LLM”) to produce a second response 706 with appended relevant information points. As shown in FIG. 7A, more than simply providing a simple list of reference documents, the first example response 704 indicates particular portions of referenced documents where relevant material is found. Moreover, to generate the second response 706, an LLM may validate information in the response by referencing the particular referenced portion(s) of each referenced document.

Moving to FIG. 7B, another example user query/response combination 712 may be produced, for example, in accordance with methods herein, and more particularly with aspects of the method 500 described with respect to FIG. 5, so as to produce a detailed, and appropriately referenced response with accurate relevant information points. By contrast, a second query/response combination 714 may illustrate challenges emerging if a generated set of relevant information points (e.g., citations) for a response is not accurate. Illustrated in red within the query/response combination 714 is an inaccurate portion of the response, which duplicates a reference sign (“[26]”) and otherwise does not fully and accurate characterize the referenced work.

It should be appreciated that the user queries and responses described with respect to FIGS. 7A and 7B are provided as examples only, and that various implementations and use cases are possible, in various embodiments.

### Example Code-specific Analysis Embodiments

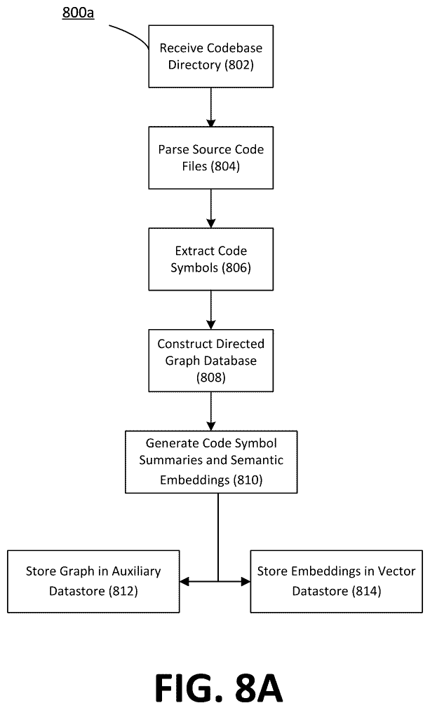

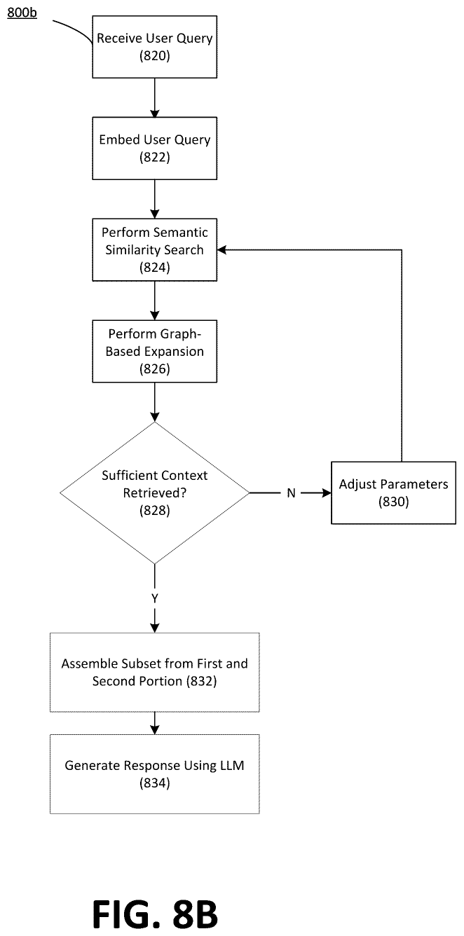

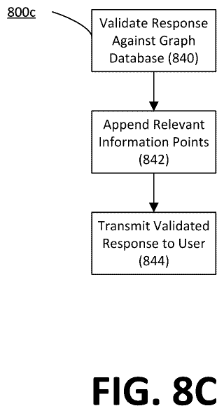

Referring now to FIG. 8A, the preprocessing phase of method 800a may be illustrated in detail. As shown, the method 800a may begin at step 802 where the system may receive a codebase directory containing source code files. The codebase directory may contain source code files in various programming languages (e.g., C/C++, Java, Python, etc.). For illustrative purposes, FIGS. 8A-8C use C/C++as an example, where the codebase directory may contain header files (.h, .hpp) and implementation files (.c, .cpp). However, the techniques described herein may be adapted to other programming languages with analogous file structures (e.g., Java with .java files, Python with .py files, JavaScript with .js files, or other languages). The document loading module 108 may access the codebase directory, similar to how it may access a folder containing PDF documents in the general RAG framework (e.g., described with respect to step 302 of method 300).

At step 804, the document loading module 108 may parse the source code files using syntax logic adapted to the programming language of the codebase. The parsing may include: (i) applying language-specific grammar rules, (ii) performing syntax tree traversal and extraction to identify code structures, (iii) removing non-semantic elements such as macros and whitespace, (iv) extracting preprocessor directives to track file dependencies, (v) grouping code symbols by function signatures, and (vi) distinguishing function declarations from definitions with associated summary text.

For example, when the document loading module 108 parses a C++ file containing “include” , “void authenticate(const std:: string& user);”, and a corresponding function definition “void authenticate(const std:: string& user) {/implementation /} ”, the parsing at step 804 may produce: (1) a preprocessor directive record indicating the file includes the standard string library, (2) a function signature “authenticate(const std::string&)” that groups all occurrences of this function, (3) a declaration record pointing to the header file location where “void authenticate(const std::string& user);” appears, (4) a definition record pointing to the implementation file location where the function body is defined, and (5) a summary text such as “Function for authenticating user credentials” derived from code comments or documentation.

Building upon the parsed content generated at step 804, at step 806, the embedding processing module 112 may extract code symbols from the parsed source code, including function names, signatures with parameter and return types, file paths and line numbers for declarations and definitions, call sites with context snippets, and include dependencies from preprocessor directives. In some embodiments, the embedding processing module 112 may include directives (e.g., “include” or “include “user\\_manager.hpp””) to connect call sites to the header files that declare functions and the implementation files that define functions, tracking multiple include chains to connect call sites to their corresponding header and implementation files, transforming the parsed output into discrete code symbol records for constructing the graph data structure.

Following the code symbol extraction at step 806, at step 808, the embedding processing module 112 may construct a graph data structure where nodes may represent extracted code symbols and edges may represent structural relationships between the code symbols. The structural relationships may include: (1) function call relationships indicating which functions call other functions, derived from call sites extracted at step 806; (2) declaration locations connecting functions to header files where they are declared, using declaration records from step 804; (3) definition locations connecting functions to implementation files where they are defined, using definition records from step 804; (4) class membership relationships indicating which methods belong to which classes, identified during syntax tree traversal at step 804; (5) inheritance relationships showing class hierarchies extracted during parsing; (6) variable usage relationships indicating which functions use which variables or data structures; and (7) include dependencies showing which files include other files, derived from preprocessor directives from step 804. The graph data structure may enable both semantic searches based on conceptual meaning and structural traversals based on code architecture during query processing.

At step 810, the embedding processing module 112 may generate summaries for each code symbol and may generate semantic embeddings of these summaries. For each function extracted from the codebase, the embedding processing module 112 may create a summary that may include: (1) the function signature extracted at step 806, (2) the summary text generated during the declaration/definition splitting at step 804, (3) a brief description derived from code comments or documentation identified during parsing, (4) the file locations for both declaration and definition, (5) parameter descriptions extracted from the function signature, (6) return value description, and (7) example callers with code snippets from the call sites identified at step 806. The embedding processing module 112 may then generate semantic embeddings of these code symbol summaries using an embedding model using an embedding model, creating vector representations that capture the semantic meaning and functionality of each code symbol. These code symbol summary embeddings may be associated with respective nodes of the graph data structure, may enable semantic similarity searches that can identify functions or other code elements relevant to a user's query based on conceptual similarity rather than exact keyword matching.

Following the generation of code symbol summaries and embeddings at step 810, the method 800a may conclude the preprocessing phase by storing the constructed data structures. At step 812, the embedding processing module 112 may store the graph data structure (constructed at step 808) in an auxiliary datastore (e.g., auxiliary datastore 152). Concurrently, at step 814, the embedding processing module 112 may store the code symbol summary embeddings (generated at step 810) in a vector datastore (e.g., vector datastore 150). This dual storage architecture may enable the KPD 102 to leverage both semantic understanding (via embeddings) and structural understanding (via graph traversal) during subsequent query processing operations.

Referring now to FIG. 8B, method 800b illustrates the hybrid retrieval approach that combines semantic similarity search with graph-based expansion. As shown, the prompt controller module 122 may receive a user query related to the codebase at step 820, akin to step 202.

Upon receipt of the user query, at step 822, the embedding engine application 106 may embed the user query to generate a query embedding in a manner similar to step 216. The query embedding may be generated using the same embedding model that was used to create the code symbol summary embeddings at step 810, ensuring consistency in the vector space and enabling meaningful similarity comparisons between the query embedding and the code symbol summary embeddings.

Following the generation of the query embedding at step 822, at step 824, the similarity search module 114 may perform semantic similarity search by comparing the query embedding generated at step 822 against the code symbol summary embeddings stored in vector datastore 150 (stored at step 814 of method 800a), in a manner similar to step 220 of FIG. 2B. This semantic search may identify code symbols whose functionality or purpose is conceptually similar to the user's query, even if the exact query terms do not appear in the function names or code, in a manner similar to step 224 of FIG. 2B. This semantic search may identify code symbols whose functionality or purpose is conceptually similar to the user's query, even if the exact query terms do not appear in the function names or code, in a manner similar to step 224 of FIG. 2B. The similarity search module 114 may use metrics such as cosine similarity, Euclidean distance, or inner product distance to rank code symbols by their relevance to the query. This semantic search may identify a first portion of corpus embeddings corresponding to semantically relevant code symbols.

Following the semantic similarity search at step 824, at step 826, the retriever application 138 may perform graph-based expansion by traversing edges in the graph data structure (stored at step 812 of FIG. 8A) from nodes corresponding to the first portion of semantically identified code symbols from step 824. The retriever application 138 may access the graph data structure stored in the auxiliary datastore 152 and traverse edges representing structural relationships established during graph construction at step 808. The graph-based expansion at step 826 may identify: (1) caller and callee functions via “calls” edges, (2) classes containing identified functions via “member_of” edges, (3) variables or data structures via “uses” edges, (4) declaration locations via “declared_in” edges to header files, (5) definition locations via “defined_in” edges to implementation files, and (6) related functions in the same module or class via membership edges.

Following the graph-based expansion at step 826, at decision 828, the retriever application 138 may determine whether sufficient context has been retrieved to generate a comprehensive and accurate response to the user query, in a manner similar to decision 222 of FIG. 2B. This determination may be based on factors such as: (1) the number of corpus embeddings retrieved from both the first portion (semantic matches) and the second portion (structural relationships), (2) the diversity of code symbols identified (e.g., whether both caller and callee functions are included, whether declaration and definition locations are both identified), (3) the depth of graph traversal achieved during the graph-based expansion at step 826, (4) the semantic similarity scores of the retrieved embeddings from step 824, and (5) whether key structural relationships (e.g., the complete call chain or class hierarchy) were captured.

If at decision 828, the retriever application 138 determines insufficient context was retrieved, method 800b may proceed to step 830, where the retriever application 138 may adjust search parameters in a manner akin to decision 222 of FIG. 2B. The parameter adjustments at step 830 may include: (1) increasing the number of semantic matches retrieved at step 824 (e.g., increasing the k value to retrieve more top-ranked code symbols), (2) adjusting the similarity threshold to include code symbols with lower similarity scores, (3) increasing the depth of graph traversal at step 826, (4) modifying the weighting between semantic and structural relevance, or (5) expanding the types of edges traversed during graph-based expansion. Following parameter adjustment at step 830, method 800b may return to step 824 to perform another semantic similarity search with the modified parameters.

Conversely, if at decision 828, the retriever application 138 determines sufficient context has been retrieved, method 800b may proceed to step 832, wherein the context manager module 124 may assemble a subset of corpus embeddings from both the first portion (semantic matches identified at step 824) and the second portion (structural relationships identified at step 826). This assembled subset may provide comprehensive context that includes both conceptually relevant code (identified through semantic similarity) and structurally related code (identified through graph traversal) necessary for complete understanding.

Following the assembly process at step 832, the assembled subset may include code-related information beyond function signatures. In a manner akin to step 806 of FIG. 8A, the assembled subset may include: (1) code snippets demonstrating function invocation patterns at call sites, (2) declaration locations referencing header files via “declared\\_in” edges from step 808, (3) definition locations referencing implementation files via “defined\\_in” edges from step 808, (4) parameter and return type specifications, (5) usage examples from captured context snippets, and (6) include dependencies specifying required file inclusions. This information may be grounded with precise file paths and line numbers extracted during the preprocessing phase, ensuring traceability and verification of code references.

Following the assembly of the subset of corpus embeddings with code-related information, at step 834, the LLM engine application 120 may generate a response to the user query based on the assembled subset from step 832, in a manner akin to step 226 of FIG. 2B. The LLM engine application 120 may synthesize information from the retrieved code symbols, their structural relationships from the graph database, and associated metadata to formulate a natural language response explaining code functionality, interactions, and codebase locations. The response may include: (1) call chains showing function invocation sequences, (2) data flow through parameters and return values, (3) architectural relationships within classes and modules, (4) declaration and definition locations for source code navigation, and (5) usage examples with typical invocation patterns. The generated response may then proceed to method 800c.

Referring now to FIG. 8C, method 800c may illustrate validation of generated responses from code-specific queries. At step 840, the model management module 130 may validate the generated response (from step 834 of FIG. 8B) against the graph data structure stored in auxiliary datastore 152. The model management module 130 may cross-reference code symbols and structural relationships mentioned in the response against corresponding nodes and edges in the graph data structure constructed at step 808. The validation at step 840 may include parsing the generated response to extract code symbol references such as function names, class names, method names, and variable names mentioned in the natural language response. The response may be generated based at least in part on the graph data structure, leveraging both the semantic embeddings and the structural relationships captured therein.

For each extracted code symbol, the model evaluation module may query the graph data structure to verify that a corresponding node exists, confirming that the LLM has not hallucinated a non-existent function or class. In some embodiments, the model evaluation module may verify that each code symbol referenced in the response maps to a node in the graph data structure, and that each structural relationship referenced in the response maps to an edge in the graph data structure. Subsequently, the model evaluation module may parse the generated response to extract structural relationship descriptions such as “function A calls function B,” “class C inherits from class D,” “method E is defined in class F,” or “file G includes header H.”

For each extracted structural relationship, the model evaluation module may query the graph data structure to verify that a corresponding edge exists connecting the appropriate nodes, confirming that the described relationships actually exist in the codebase. Additionally, the model evaluation module may verify that function signatures mentioned in the response (including parameter types and return types) match the function signatures stored in the graph database nodes, which were extracted during step 806. The model evaluation module may further verify that declaration locations mentioned in the response match the “declared\\_in” edges in the graph database, ensuring that references to header files are accurate. Finally, the model evaluation module may verify that definition locations mentioned in the response match the “defined\\_in” edges in the graph database, ensuring that references to implementation files are accurate. This validation process may detect hallucinations where the LLM engine application 120 may have generated plausible-sounding but non-existent code symbols, incorrect structural relationships, inaccurate function signatures, or wrong file locations.

Following validation at step 840, at step 842, the citation generating module 146 may append relevant information points to the validated response in a manner akin to step 228. The relevant information points may include: (1) file paths for declarations (e.g., “declared in auth/authentication. h, line 12”) retrieved from “declared\\_in” edges in the graph database, (2) file paths for definitions (e.g., “defined in auth/authentication.cpp, line 45”) retrieved from “defined\\_in” edges, (3) parameter and return types extracted from function signatures stored in graph database nodes, (4) code snippets from call sites captured during step 806 of FIG. 8A, and (5) links to related functions identified during graph-based expansion at step 826 of FIG. 8B. These relevant information points may ground the response with precise file/line/snippet references, ensuring that factual claims can be traced to specific source code locations and enabling user verification of the original code.

At step 844, the NIC 180 may transmit the validated response with appended relevant information points to the user, in a manner similar to step 236 of FIG. 2C. The user may receive a response that: (1) explains the queried code functionality in natural language, (2) includes verifiable references to the actual source code locations (both declarations and definitions), (3) provides code snippets showing typical usage patterns, (4) describes structural relationships between code symbols (calls, inheritance, membership), and (5) minimizes the risk of hallucinations or inaccuracies through the validation performed at step 840. The user may use the provided file paths and line numbers to navigate directly to the relevant code in the codebase, examine the actual implementations, and verify the information provided in the response.

### FURTHER INFORMATION

Further description of techniques described in the foregoing is provided in Vansh Sharma, Venkat Raman, A reliable knowledge processing framework for combustion science using foundation models, Energy and AI, Volume 16, 2024, 100365, ISSN 2666-5468, which is hereby incorporated by reference herein in its entirety.

This detailed description is to be construed as exemplary only and does not describe every possible embodiment, as describing every possible embodiment would be impractical, if not impossible. One could implement numerous alternate embodiments, using either current technology or technology developed after the filing date of this application. Upon reading this disclosure, those of ordinary skill in the art will appreciate still additional alternative structural and functional designs for the methods and systems described herein through the disclosed principles herein. Thus, while particular embodiments and applications have been illustrated and described, it is to be understood that the disclosed embodiments are not limited to the precise construction and components disclosed herein. Various modifications, changes, and variations, which will be apparent to those of ordinary skill in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

While the preferred embodiments of the invention have been described, it should be understood that the invention is not so limited, and modifications may be made without departing from the invention. The scope of the invention is defined by the appended claims, and all devices that come within the meaning of the claims, either literally or by equivalence, are intended to be embraced therein. It is therefore intended that the foregoing detailed description be regarded as illustrative rather than limiting, and that it be understood that it is the following claims, including all equivalents, that are intended to define the spirit and scope of this invention.

What is claimed is:

1. A computer-implemented method comprising:
obtaining, via one or more processors, a user query from a user;
embedding, via the one or more processors, the user query to generate one or more query embeddings;
identifying, via the one or more processors, from a plurality of corpus embeddings representing content of one or more documents in a document corpus, a subset of one or more corpus embeddings relevant to the user query, based upon comparison of the one or more query embeddings to the plurality of corpus embeddings;
associating, via the one or more processors, one or more relevant information points with the subset of one or more corpus embeddings, the one or more relevant information points indicating one or more locations in the document corpus corresponding to the subset of one or more corpus embeddings;
generating, via the one or more processors, a response to the user query based upon the subset of one or more corpus embeddings and the one or more relevant information points; and
providing, via the one or more processors, the response to the user.

2. The computer-implemented method of claim 1, further comprising:
partitioning, via the one or more processors, the document corpus into a plurality of document chunks, wherein adjacent document chunks share overlapping content; and
generating, via the one or more processors, the plurality of corpus embeddings for each document chunk using a pre-trained embedding model, wherein each corpus embedding represents semantic content of a corresponding document chunk.

3. The computer-implemented method of claim 2, wherein the one or more documents in the document corpus includes one or more source code files, and wherein partitioning the document corpus includes:
parsing, via the one or more processors, the one or more source code files;
constructing, via the one or more processors, a graph data structure having nodes representing code symbols and edges representing structural relationships between the code symbols, wherein each node is associated with a corresponding corpus embedding from the plurality of corpus embeddings;
storing, via the one or more processors, the graph data structure in an auxiliary datastore; and
generating, via the one or more processors, the response based at least in part on the graph data structure.

4. The computer-implemented method of claim 3, further comprising:
assembling the subset of one or more corpus embeddings from a first portion identified using semantic similarity search on code symbol summary embeddings associated with respective nodes of the graph data structure, and a second portion identified using graph-based expansion by traversing a plurality of edges in the graph data structure from a plurality of nodes corresponding to the first portion.

5. The computer-implemented method of claim 3, further comprising:
validating the response by verifying that each code symbol referenced in the response maps to a node in the graph data structure, and that each structural relationship referenced in the response maps to an edge in the graph data structure; and
modifying the response when inconsistencies are detected.

6. The computer-implemented method of claim 1, wherein identifying the subset of one or more corpus embeddings includes:
executing, via the one or more processors, a similarity search using a similarity criterion selected from: (i) cosine similarity, (ii) maximum marginal relevance (MMR), or (iii) inner product distance; and
ranking, via the one or more processors, two or more identified corpus embeddings based upon relevance to the user query.

7. The computer-implemented method of claim 1, further comprising:
comparing, via the one or more processors, the response against metadata and context of the subset of one or more corpus embeddings to detect inaccuracies in the response;
retrieving additional corpus embeddings when one or more inaccuracies are detected in the response; and
regenerating, via the one or more processors, affected portions of the response based upon the additional corpus embeddings.

8. The computer-implemented method of claim 1, further comprising:
storing, via the one or more processors, the plurality of corpus embeddings in a datastore with associated metadata;
retrieving, for each corpus embedding from the subset of one or more corpus embeddings, supplemental metadata from one or more auxiliary datastores; and
generating, via the one or more processors, the response based upon at least in part on the supplemental metadata.

9. The computer-implemented method of claim 1, further comprising:
determining, via the one or more processors, a size or number of corpus embeddings in the subset of one or more corpus embeddings based upon at least one or any combination thereof: (i) a complexity of the user query, (ii) a length of the user query, (iii) a semantic diversity of the document corpus, (iv) memory usage in computational resources, (v) a token limit of a language model used to generate the response, or (vi) a token limit of an embedding model used to generate the plurality of corpus embeddings.

10. The computer-implemented method of claim 1, further comprising:
extracting, via the one or more processors, one or more citation references from the subset of one or more corpus embeddings using pattern matching;
comparing the one or more citation references against a reference section of corresponding source documents in the document corpus; and
including verified citation references in the one or more relevant information points.

11. A computing system comprising:
one or more processors; and
one or more memories having stored thereon processor-executable instructions, that when executed, cause the computing system to perform operations comprising:
obtaining a user query from a user;
embedding the user query to generate one or more query embeddings;
identifying from a plurality of corpus embeddings representing content of one or more documents in a document corpus, a subset of one or more corpus embeddings relevant to the user query, based upon comparison of the one or more query embeddings to the plurality of corpus embeddings;
associating, one or more relevant information points with the subset of one or more corpus embeddings, the one or more relevant information points indicating one or more locations in the document corpus corresponding to the subset of one or more corpus embeddings;
generating a response to the user query based on the subset of one or more corpus embeddings and the one or more relevant information points; and
providing the response to the user.

12. The computing system of claim 11, wherein the processor-executable instructions, when executed, cause the computing system to perform operations comprising:
partitioning the document corpus into a plurality of document chunks, wherein adjacent document chunks share overlapping content; and
generating the plurality of corpus embeddings for each document chunk using a pre-trained embedding model, wherein each corpus embedding represents semantic content of a corresponding document chunk.

13. The computing system of claim 12, wherein the one or more documents in the document corpus includes one or more source code files, and wherein the processor-executable instructions, when executed, cause the computing system to perform operations comprising:
parsing the one or more source code files;
constructing a graph data structure having nodes representing code symbols and edges representing structural relationships between the code symbols, wherein each node is associated with a corresponding corpus embedding from the plurality of corpus embeddings;
storing the graph data structure in an auxiliary datastore; and
generating the response based at least in part on the graph data structure.

14. The computing system of claim 13, wherein the processor-executable instructions, when executed, cause the computing system to perform operations comprising:
assembling the subset of one or more corpus embeddings from a first portion identified using semantic similarity search on code symbol summary embeddings associated with respective nodes of the graph data structure, and a second portion identified using graph-based expansion by traversing edges in the graph data structure from nodes corresponding to the first portion.

15. The computing system of claim 13, wherein the processor-executable instructions, when executed, cause the computing system to perform operations comprising:
validating the response by verifying that each code symbol referenced in the response maps to a node in the graph data structure, and that each structural relationship referenced in the response maps to an edge in the graph data structure; and
modifying the response when inconsistencies are detected.

16. The computing system of claim 11, wherein the processor-executable instructions, when executed, cause the computing system to perform operations comprising:
executing a similarity search using a similarity criterion selected from: (i) cosine similarity, (ii) maximum marginal relevance (MMR), or (iii) inner product distance; and
ranking two or more identified corpus embeddings based upon relevance to the user query.

17. The computing system of claim 11, wherein the processor-executable instructions, when executed, cause the computing system to perform operations comprising:
comparing the response against metadata and context of the subset of one or more corpus embeddings to detect inaccuracies in the response;
retrieving additional corpus embeddings when one or more inaccuracies are detected in the response; and
regenerating affected portions of the response based upon the additional corpus embeddings.

18. The computing system of claim 11, wherein the processor-executable instructions, when executed, cause the computing system to perform operations comprising:
storing the plurality of corpus embeddings in a datastore with associated metadata;
retrieving, for each corpus embedding from the subset of one or more corpus embeddings, supplemental metadata from one or more auxiliary datastores; and
generating the response based upon at least in part on the supplemental metadata.

19. The computing system of claim 11, wherein the processor-executable instructions, when executed, cause the computing system to perform operations comprising:
determining a size or number of corpus embeddings in the subset of one or more corpus embeddings based upon at least one of: (i) a complexity of the user query, (ii) a length of the user query, (iii) a semantic diversity of the document corpus, (iv) memory usage in computational resources, (v) a token limit of a language model used to generate the response, or (vi) a token limit of an embedding model used to generate the plurality of corpus embeddings.

20. A non-transitory computer-readable medium storing processor-executable instructions, that when executed by one or more processors, cause the one or more processors to perform operations comprising:
obtaining a user query from a user;
embedding the user query to generate one or more query embeddings;
identifying from a plurality of corpus embeddings representing content of one or more documents in a document corpus, a subset of one or more corpus embeddings relevant to the user query, based on comparison of the one or more query embeddings to the plurality of corpus embeddings;
associating, one or more relevant information points with the subset of one or more corpus embeddings, the one or more relevant information points indicating one or more locations in the document corpus corresponding to the subset of one or more corpus embeddings;
generating a response to the user query based on the subset of one or more corpus embeddings and the one or more relevant information points; and
providing the response to the user.
